(19) United States
(12) Patent Application Publication
(10) Pub. No.: US 2008/0211902 A1
(43) Pub. Date: Sep. 4, 2008

(54) Imaging device

(75) Inventor: Kenichiro Ayaki, Asaka-shi (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: FUJIFILM Corporation, Tokyo (JP)

(21) Appl. No.: 12/073,161

(22) Filed: Feb. 29, 2008

(30) Foreign Application Priority Data
Mar. 2, 2007 (JP) 2007-053455

(51) Int. Cl. H04N 7/00

(52) U.S. Cl. 348/36; 348/E07.001

(57) ABSTRACT

An imaging device is provided with an all pixel driving mode which reads the signal charges of pixels of the entire frame and a specific line driving mode which read the signal charges of pixels on the specific lines on the area sensor. In the all pixel driving mode, the motion vector of the object is detected to calculate the amount of relative movement of an object on the screen based on the detected motion vector. Next, a shooting cycle is determined based on the amount of relative movement, and the slit shooting is performed at the determined cycle in the specific line driving mode. The shot slit image is spliced to the latest shot slit image. Thereby the imaging device can produce a long panoramic image with a correct aspect ratio.

### BACKGROUND OF THE INVENTION

1. Field of the Invention

The present invention relates to an imaging device, and in particular, to an imaging device for producing a long panoramic image by slit imaging.

2. Description of the Related Art

Hitherto, an imaging device for producing a long panoramic image by slit exposure of a film has been known. In addition, a technique has been disclosed in which a digital camera including an imaging element produces a long panoramic image. Japanese Patent Application Laid-Open No. 05-137076 describes a technique in which area sensors are formed such that substantially one to ten lines thereof are shifted at a slow speed and the other lines at a high speed to realize a pure-electric slit camera which eliminates the need for a mechanical slit plate. Japanese Patent Application Laid-Open No. 2005-203845 describes a technique in which an optimum slit speed, frame speed and slit width are calculated from the speed of an object and the distance between the object and a camera to shoot the object at the calculated frame speed and to segment a slit image with the calculated slit width, thereby synthesizing a panoramic image.

The imaging device described in Japanese Patent Application Laid-Open No. 05-137076, however, produces a horizontally or a vertically long slit image depending on the relative speed of an object, which presents a drawback of providing an image with a incorrect aspect ratio. The imaging device described in Japanese Patent Application Laid-Open No. 2005-203845, on the other hand, provides an image with a correct aspect ratio, however, it requires to measure the speed of an object and the distance between the object and a camera by using a measuring device such as a Doppler radar system, which offers a drawback of requiring a large number of measuring instruments and a large amount of calculations.

### SUMMARY OF THE INVENTION

The present invention has been made in view of the above situations and for its object to provide an imaging device capable of simply producing a long panoramic image with a correct aspect ratio using an area sensor independently of the relative speed of an object.

To achieve the above object, according to a first aspect of the present invention, an imaging device having a slit image shooting device which reads a slit image from a slit shooting area on an area sensor to shoot the slit image and a panoramic image forming device which splices the shot slit images together to produce a long panoramic image, the imaging device comprises: a motion detecting device which reads an image from a motion detecting area on the area sensor at a predetermined cycle and detects an amount of relative movement of an object on the area sensor per unit time based upon the read image; and a control device which controls a reading cycle to read a slit image by the slit image shooting device based upon the detected amount of relative movement and a slit width of the slit shooting area to produce a panoramic image with a correct aspect ratio.

This enables easily producing a long panoramic image with a correct aspect ratio.

To achieve the above object, according to a second aspect of the present invention, An imaging device having a slit image shooting device which reads a slit image from a slit shooting area on an area sensor to shoot the slit image and a panoramic image forming device which splices the shot slit images together to produce a long panoramic image, the imaging device comprises: a motion detecting device which reads an image from a motion detecting area on the area sensor at a predetermined cycle and detects, based upon the read image, an amount of relative movement of an object on the area sensor per reading cycle for reading the slit image by the slit image shooting device; and a control device which controls a slit width of the slit shooting area so that the detected amount of relative movement coincides with the slit width of the slit shooting area.

This enables easily producing a long panoramic image with a correct aspect ratio.

According to a third aspect of the present invention, in the imaging device described in the first and the second aspect, the motion detecting device detects the amount of relative movement of the object orthogonal to the slit shooting area.

According to a fourth aspect of the present invention, in the imaging device described in any of the first to third aspect, the motion detecting device reads an image from the motion detecting area on the area sensor before the slit image shooting device starts shooting the slit image and the control device causes the slit image shooting device to start shooting the slit image after the motion detecting device has detected the amount of relative movement of the object.

According to a fifth aspect of the present invention, the imaging device described in any of the first to third aspect further comprises a shutter button which instructs the imaging device to perform a preparatory shooting operation when it is half-depressed and a shooting operation when it is fully-depressed. And in the imaging device, the motion detecting device reads an image from the motion detecting area on the area sensor at a predetermined cycle when the shutter button is half-depressed, and the control device causes the slit image shooting device to start shooting the slit image when the shutter button is fully-depressed.

According to a sixth aspect of the present invention, in the imaging device described in the fourth or the fifth aspect, the area sensor is a CCD area sensor, the motion detecting device reads an image from all pixels on the CCD area sensor, and the slit image shooting device reads the slit image only from one to plural horizontal lines of the CCD area sensor at a faster rate than reading from all pixels.

According to a seventh aspect of the present invention, in the imaging device described in the second aspect, the motion detecting device reads an image from the motion detecting area on the area sensor before and while the slit image shooting device shoots the slit image, and the control device causes the slit image shooting device to start shooting the slit image after the motion detecting device has detected the amount of relative movement of the object, and controls the slit width of the slit shooting area in real time so that the amount of relative movement sequentially detected by the motion detecting device coincides with the slit width of the slit shooting area.

This enables producing a long panoramic image with a correct aspect ratio even if acceleration is applied to the object.

According to an eighth aspect of the present invention, in the imaging device described in any of the first to the seventh aspect, the slit shooting area is a central portion of the area sensor.

This enables using the central portion of the screen where lens optical characteristics are superior and producing a long panoramic image with a satisfactory image quality.

According to a ninth aspect of the present invention, in the imaging device described in any of the first to the eighth aspect, the motion detecting areas on the area sensor are provided on the left and the right of the slit shooting area, the motion detecting device detects the object moving relatively rightward on the area sensor based on the image obtained from the left motion detecting area and detects the object moving relatively leftward on the area sensor based on the image obtained from the right motion detecting area, and the panoramic image forming device splices the slit images together leftward when the motion detecting device detects that the object moves relatively rightward on the area sensor and splices the slit images together rightward when the motion detecting device detects that the object moves relatively leftward, to form a long panoramic image.

This enables producing a long panoramic image which is same in the direction as viewed when shot.

According to a tenth aspect of the present invention, the imaging device described in any of the first to the ninth aspect, further comprises: a shooting trigger area which is set inside of a left and a right motion detecting areas on the area sensor, the left and the right motion detecting areas are provided on the left and the right of the slit shooting area and on the end of the area sensor; and a shooting trigger detecting area which detects change in the image in the shooting trigger area. And in the imaging device, the control device causes the slit image shooting device to start reading the slit image, when the motion detecting device detects the movement of the object based on the image of the left or the right motion detecting area and the shooting trigger detecting device detects change in the image in the shooting trigger area.

This allows minimizing places where objects are not shot. In addition, it prevents the shutter opportunity from being lost owing to the object passing through the shooting slit before the slit shooting is started.

According to an eleventh aspect of the present invention, the imaging device described in any of the first to the tenth aspect, further comprises: a shooting finish trigger area which is set inside of a left and a right motion detecting areas on the area sensor, the left and the right motion detecting areas are provided on the left and the right of the slit shooting area and on the end of the area sensor; and a shooting-finish trigger detecting device which detects as to whether the image before shooting is started coincides with the image after shooting is started, in the shooting finish trigger area. And in the imaging device, the control device causes the slit image shooting device to stop shooting the slit image, when the shooting-finish trigger detecting device detects the coincidence of the images for a certain time period or more after the slit image shooting device has started reading the slit image.

This enables minimizing places where objects are not shot.

According to a twelfth aspect of the present invention, in the imaging device described in the fourth, the fifth or the seventh aspect, the motion detecting device detects the direction in which the object moves leftward, rightward, upward or downward on the area sensor, and the slit image shooting device sets the slit shooting area to the direction orthogonal to the direction in which the object moves detected by the motion detecting device.

This enables producing a long panoramic image without regard for camera attitude.

According to a thirteenth aspect of the present invention, in the imaging device described in the fourth, the fifth or the seventh aspect, the motion detecting device detects the direction in which the object moves on the area sensor, and the slit image shooting device sets the slit shooting area to the end of the area sensor where the rear end of the object lastly passes according to the direction in which the object moves detected by the motion detecting device.

This enables saving the time from the detection of the direction in which the object moves to the start of the slit shooting and preventing the object from passing through the slit shooting area before the shooting is started.

According to a fourteenth aspect of the present invention, the imaging device described in any of the first to the thirteenth aspect, further comprises a recording device which divides the shot panoramic image so as to have the aspect ratio of the standard image, forms image files for each of the divided images and records them in the recording medium.

This enables reproducing an image in the same manner as the standard image is reproduced, which eliminates the need for having a special reproduction mode.

According to a fifteenth aspect of the present invention, in the imaging device described in the fourteenth aspect, the recording device records information indicating that an image file corresponds to a series of a panoramic image, in the tags of a plurality of image files formed correspondingly with the shot panoramic image.

This permits splicing a plurality of image groups by using a dedicated software to reproduce or print them as a long panoramic image.

According to a sixteenth aspect of the present invention, the imaging device described in the first to fifteenth aspect, further comprises: a storing device which stores a first slit image shot by the slit image shooting device before the motion detecting device detects the amount of motion of the object in the motion detecting area; a background detecting device which compares a first slit image stored in the storing device with a second slit image sequentially shot by the slit image shooting device, and detects a background image of the object from the second slit image; and a replacing device which replaces the detected background image out of the second slit images with an image in a specified color.

This enables producing a long panoramic image only with an object and without the background of the object.

A method which comprises steps and functions performed by the imaging device according the aspects of the present invention may also achieve the object of the present invention.

According to the present invention, there is provided an imaging device capable of easily producing a long panoramic image with a correct aspect ratio independently of the amount of relative movement of an object.

### BRIEF DESCRIPTION OF THE DRAWINGS

FIG. 1 is an external view of the digital camera 10;

FIG. 2 is a block diagram illustrating one example of the internal configuration of the digital camera 10 of the first embodiment;

FIG. 3 is a schematic diagram illustrating the configuration of the CCD 45 of the digital camera 10;

FIG. 4 is a schematic diagram illustrating the operation of the CCD 45 in the all pixel driving mode;

FIG. 5 is a schematic diagram illustrating the operation of the CCD 45 in the specific line driving mode;

FIG. 6 is a schematic diagram illustrating a slit shooting;

FIG. 7 is a flow chart illustrating the operation of the digital camera 10 according to the first embodiment;

FIGS. 8A and 8B are schematic views illustrating the shooting area 84 in which 84 an object does not exist at the motion vector detecting process;

FIGS. 9A and 9B are schematic views illustrating the shooting area 84 which the object enters at the motion vector detecting process;

FIGS. 10A and 10B are schematic views illustrating the shooting area 84 where the object further travels as compared with FIGS. 9A and 9B;

FIGS. 11A and 11B are schematic views illustrating the first slit shooting and the shot slit image;

FIGS. 12A and 12B are schematic views illustrating the sixth slit shooting and the image in which the shot slit images are spliced together;

FIGS. 13A and 13B are schematic views illustrating the twelfth slit shooting and the image in which the shot slit images are spliced together;

FIG. 14 is a schematic view illustrating a long panoramic image shot by the digital cameral of the first embodiment;

FIG. 15 is a block diagram illustrating the internal configuration of the digital camera 10 of the second embodiment;

FIG. 16 is a schematic diagram of the CMOS 51;

FIG. 17 is a flow chart illustrating the operation of the digital camera 10 of the third embodiment;

FIG. 18 is a schematic view illustrating the shot long panoramic image;

FIG. 19 is a flow chart illustrating the operation of the digital camera 10 of the fourth embodiment;

FIGS. 20A, 20B, 20C, 20D and 20E are schematic views illustrating the process for splicing the images;

FIG. 21 is a flow chart illustrating the operation of the digital camera 10 of the fifth embodiment;

FIG. 22 is a flow chart illustrating the operation of the digital camera 10 of the sixth embodiment;

FIGS. 23A and 23B are schematic views illustrating the first slit shooting and the shot slit image;

FIGS. 24A and 24B are schematic views illustrating the sixth slit shooting and the image in which the shot slit images are spliced together;

FIGS. 25A and 25B are schematic views illustrating the twelfth slit shooting and the image in which the shot slit images are spliced together;

FIG. 26 is a long panoramic image shot by the digital cameral of the sixth embodiment;

FIG. 27 is a flow chart illustrating the operation of the digital camera 10 of the seventh embodiment;

FIGS. 28A and 28B are schematic views illustrating the slit shooting in the case where the object moves leftward and the shot slit image;

FIGS. 29A and 29B are schematic views illustrating the slit shooting in the case where the object moves rightward and the shot slit image;

FIG. 30 is a flow chart illustrating the operation of the digital camera 10 of the eighth embodiment;

FIG. 31 is a schematic view illustrating the slit shooting in case where an object moves from right to left;

FIG. 32 is a flow chart illustrating the operation of the digital camera 10 of the ninth embodiment;

FIGS. 33A, 33B and 33C are schematic views illustrating the slit shooting in case where the object is passing;

FIG. 34 is a flow chart illustrating the operation of the digital camera 10 of the tenth embodiment;

FIG. 35 is a schematic view illustrating four motion vector detecting areas on the shooting screen;

FIGS. 36A, 36B, 36C and 36D are schematic views illustrating relationship between the direction in which the object moves on the shooting screen and the shooting slit area 81;

FIG. 37 is a flow chart illustrating the operation of the digital camera 10 of the eleventh embodiment; and

FIGS. 38A and 38B are schematic views illustrating the direction in which the object moves and the shooting area 84.

### DETAILED DESCRIPTION OF THE PREFERRED EMBODIMENTS

Preferred embodiments of an imaging device according to the present invention are described below with reference to the accompanied drawings.

### First Embodiment

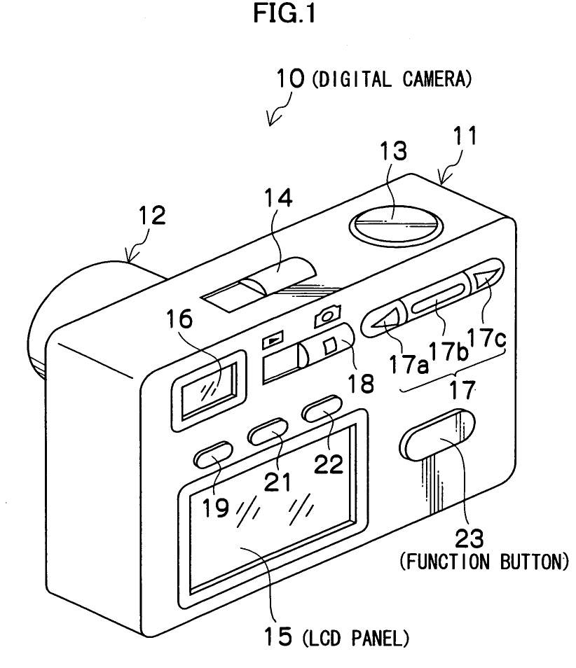

A digital camera 10 of a first embodiment according to the present invention is described with reference to FIGS. 1 to 14.

The digital camera 10 illustrated in FIG. 1 is provided with a lens barrel 12 incorporating an imaging lens on the front face of the camera body 11, a shutter button 13 and a power supply switch 14 on the upper face thereof. The shutter button 13 has a switch S1 which is half-depressed to turn it on to make shooting preparations such as focus lock and photometry, and a switch 2 which is fully-depressed to turn it on to capture images.

The digital camera 10 is provided on its back face of the camera body 11 with an LCD panel 15, a finder eyepiece window 16, a selection key 17 composed of a left key 17a, a decision key 17b and a right key 17c, a mode changeover switch 18, an LCD panel ON/OFF button 19, a camera-shake reduction button (image stabilization button) 21, a cancellation button 22 and a function button 23. The mode changeover switch 18 is capable of changing over a shooting mode in which shooting is performed and a reproduction mode in which a shot image is reproduced. The LCD panel 15 is capable of being used as an electronic viewfinder to display a moving image (or, an image through-the-lens) and displaying the shot image before recorded (or, a previewing image) in the shooting mode and displaying a reproduced image read from a memory card mounted on the camera in the reproduction mode. The LCD panel 15 displays various menu screens according to the operation of a function button 23 at the time of manually setting operation modes, white balance, the number of image pixels (resolution) and sensitivity and displays a screen used for a graphical user interface (GUI) by which a user can manually set items according to the operation of the selection button 17.

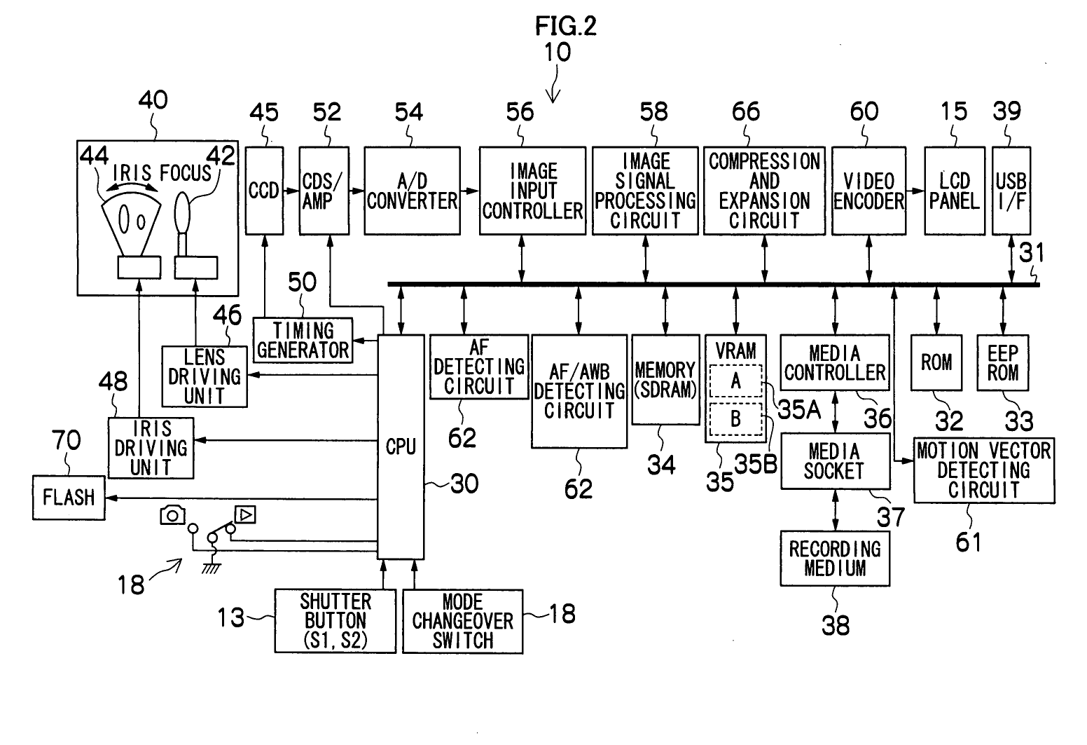

FIG. 2 is a block diagram illustrating one example of the internal configuration of the digital camera 10 of the first embodiment according to the present invention.

A CPU 30 functions as a control device for controlling the digital camera 10 according to a predetermined program and as a calculating device for performing various calculations such as automatic exposure (AE) calculation, automatic focus (AF) adjustment calculation and white balance (WB) adjustment calculation.

A ROM 32 connected to the CPU 30 through a bus 31 stores various data required for the programs and controls executed by the CPU 30. An EEPROM 33 stores various constants and information as to CCD pixel defect information and the operation of the camera.

A memory (SDROM) 34 is used as a program expansion area and a calculation work area of the CPU 30 and as an area where image data and voice data are temporally stored. A VRAM 35 is a temporally storage memory dedicated for image data and includes an area A 35A and an area B 35B. The memory 34 and the VRAM 35 can be commonly used.

When a power supply is turned on, the CPU 30 detects that the power has been turned on, turns on the power supply in the camera, and displays an opening image stored in the ROM 32 during a certain period of time and thereafter brings the camera into the shooting standby state in the shooting mode. The CPU 30 causes the LCD panel 15 to display a moving picture (or, an image through-the-lens) in the shooting standby state.

A user (shooter) frames, confirms an image desired to be shot and a shot image, and sets shooting conditions while viewing the image through-the-lens which is displayed on the LCD panel 15.

When the shutter button 13 is depressed in the shooting standby state, a lens driving unit 46 and an iris driving unit 48 controlled by the CPU 30 appropriately drive a focus lens 42 and an iris 44 of a lens unit 40 respectively to adjust focus and iris diaphragm. A motion vector detecting circuit 61 detects the motion vector of an object in a specific line driving mode described later.

Light transmitted through the lens unit 40 is imaged on the light receiving surface of the CCD 45. A large number of photo diodes (photo detectors) is two-dimensionally arranged on the light receiving surface of the CCD 45. A red (R), green (G) and blue (B) primary-color color-filters are arranged correspondingly with the photo diodes at a predetermined configuration. The CCD 45 functions as an electric shutter for controlling the charge storage time (or, shutter speed) during which electric charges on the photo diodes are stored. The CPU 30 controls the charge storage time in the CCD 45 through a timing generator 50.

An object image which is imaged on the light receiving surface of the CCD 45 is converted by photo diodes to a signal charge, the amount of which corresponds to the amount of incident light. The signal charges stored in the photo diodes are sequentially read as voltage signals corresponding to the signal charge (image signals) based on driving pulses provided by the timing generator 50 according to the instruction of the CPU 30.

The signals output from the CCD 45 are sent to a CDS/AMP circuit 52 and the R, G and B signals of each pixel are sampled and held (correlated double sampling), amplified and then applied to an A/D converter 54.

The dot sequential R, G and B signals converted to digital signals by the A/D converter 54 are stored in the memory 34 through an image input controller 56.

An image signal processing circuit 58 processes the R, G and B signals stored in the memory 34 according to the instruction of the CPU 30, converts the signals to a luminance signal (or, Y signal) and a color difference signal (or, Cr and Cb signals) and performs predetermined processes such as gamma correction. The image data thus processed is stored in the VRAM 35.

The above YC signals stored in the VRAM 35 are compressed by a compression and expansion circuit 66 according to a predetermined format, thereafter, the compressed signals are recorded in a recording medium 38 inserted into a media socket 37 through a media controller 36. For example, the signals are recorded using the JPEG format.

When the mode changeover switch 18 is operated to select the reproduction mode, the image file in the latest frame recorded in the recording medium 38 is read out through the media controller 36. The compressed data of the read image file is expanded to a decompressed YC signal through the compression and expansion circuit 66.

The expanded YC signal is converted to signal format for display by a video encoder 60 and output to the LCD panel 15. Thus, the latest frame recorded in the recording medium 38 is displayed on the LCD panel 15.

Operating the left key 17a or the right key 17c during the reproduction of an image in the latest frame enables changing over the file to be reproduced (forward frame feeding or reverse frame feeding). The image file at the position where a frame feeding is performed is read from the recording medium 38 and a still image or a moving image is reproduced and displayed on the LCD panel 15 similarly to the above.

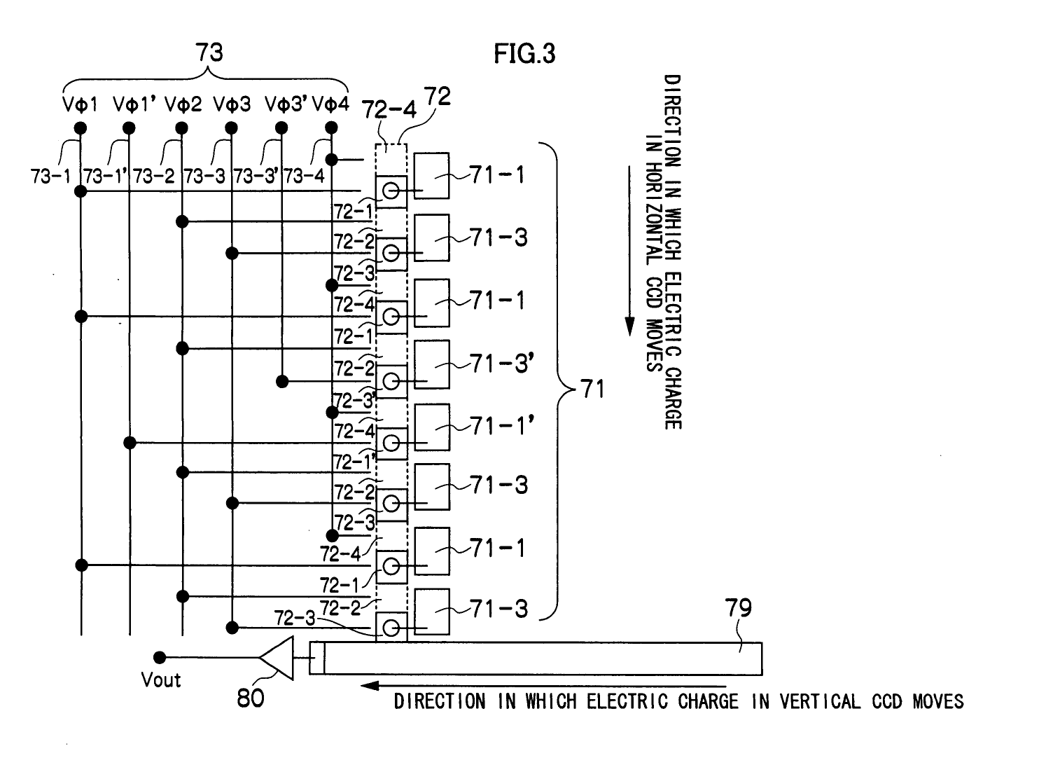

The following is a description of an all pixel driving mode in which the signal charges of all pixels of the entire frame on the CCD 45 are read (in other words, the entire frame driving mode), and a specific line driving mode in which the signal charges of pixels on the specific lines are read, with reference to FIGS. 3 to 5.

FIG. 3 is a schematic diagram illustrating the configuration of the CCD 45. The CCD 45 includes a photo diode 71 for performing photoelectric conversion and electric charge storage, a vertical transfer CCD 72, a bus line 73 for vertical transfer clocks, a horizontal transfer CCD 79 and an electric charge voltage conversion unit 80, etc.

The vertical transfer CCD 72 includes a CCD 72-1 connected to a bus line 73-1, a CCD 72-2 connected to a bus line 73-2, a CCD 72-3 connected to a bus line 73-3, a CCD 724 connected to a bus line 734, a CCD 72-1′ connected to a bus line 73-1′ and a CCD 72-3′ connected to a bus line 73-3′. Vertical transfer clocks Vφ1, Vφ1′, Vφ2, Vφ3, Vφ3′ and Vφ4 are supplied to the bus lines 73-1, 73-1′, 73-2, 73-3, 73-3′, and 73-4 respectively. Only CCDs corresponding to pixels of the shooting slit area 81 described later are connected to the bus lines 73-1′ or 73-3′ and the other CCDs are connected to the bus lines 73-1, 73-2, 73-3 and 73-4.

The photo diode 71 includes photo diodes 71-1, 71-3, 71-1′ and 71-3′ arranged on CCDs 72-1, 72-3, 72-1′ and 72-3′ respectively. The vertical transfer clocks Vφ1, Vφ3, Vφ1′ and Vφ3′ are set so as to take ternary levels: low level (level L) for transferring; medium level (level M); and high level (level H) for reading the photo diode. When the vertical transfer clock Vφ1 is in level H, the photo diode 71-1 can be read. When the vertical transfer clock Vφ3 is in level H, the photo diode 71-3 can be read. When the vertical transfer clock Vφ1 ′ is in level H, the photo diode 71-1′ can be read. When the vertical transfer clock Vφ3′ is in level H, the photo diode 71-3′ can be read.

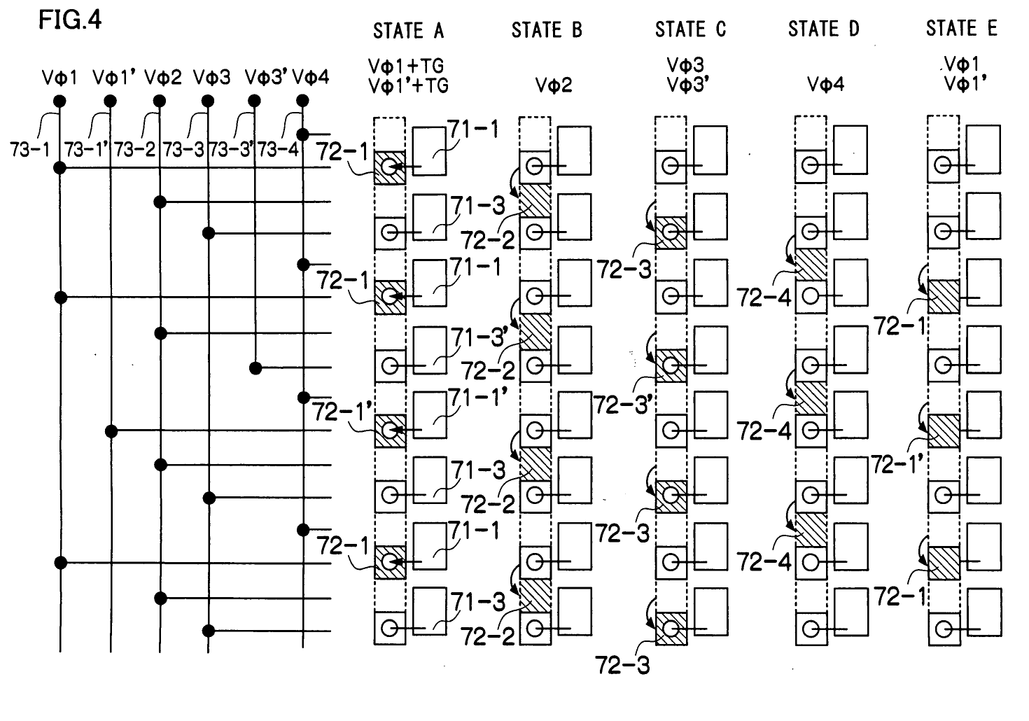

The operation of the CCD 45 in the all pixel driving mode is described below with reference to FIG. 4.

First, when the bus lines 73-1 and 73-1′ are supplied with an electric potential of level H (reading pulse TG), electric charges of the photodiodes 71-1 and 71-1′ are read out to the CCDs 72-1 and 72-1′ (state A in FIG. 4). After that, the vertical transfer clocks Vφ1 to Vφ4 are used to sequentially transfer electric charges downward in FIG. 4 (refer to state B to state E in FIG. 4). In FIG. 4, the electric charges to be transferred are transferred are indicated by slanting lines. At this point, the same clocks as the vertical transfer clocks Vφ1 and Vφ3 are used in the vertical transfer clocks Vφ′ and Vφ3′. Each time electric charges downward by one step from the state A to the state B and from state B to state C in FIG. 4, for example, the electric charges reaching a horizontal CCD 79 (not shown) positioned at the bottom of the vertical transfer CCD are read out by the horizontal transfer CCD 79. After all the electric charges have been read, the bus lines 73-3 and 73-3′ are supplied with an electric potential of level H (reading pulse TG) then electric charges of the photo diodes 71-3 and 71-3′ are read out to the CCDs 72-3 and 72-3′. After that, a vertical transfer and a horizontal transfer are repeated in the same manner as the above. The signal charges of the entire frame are thus read.

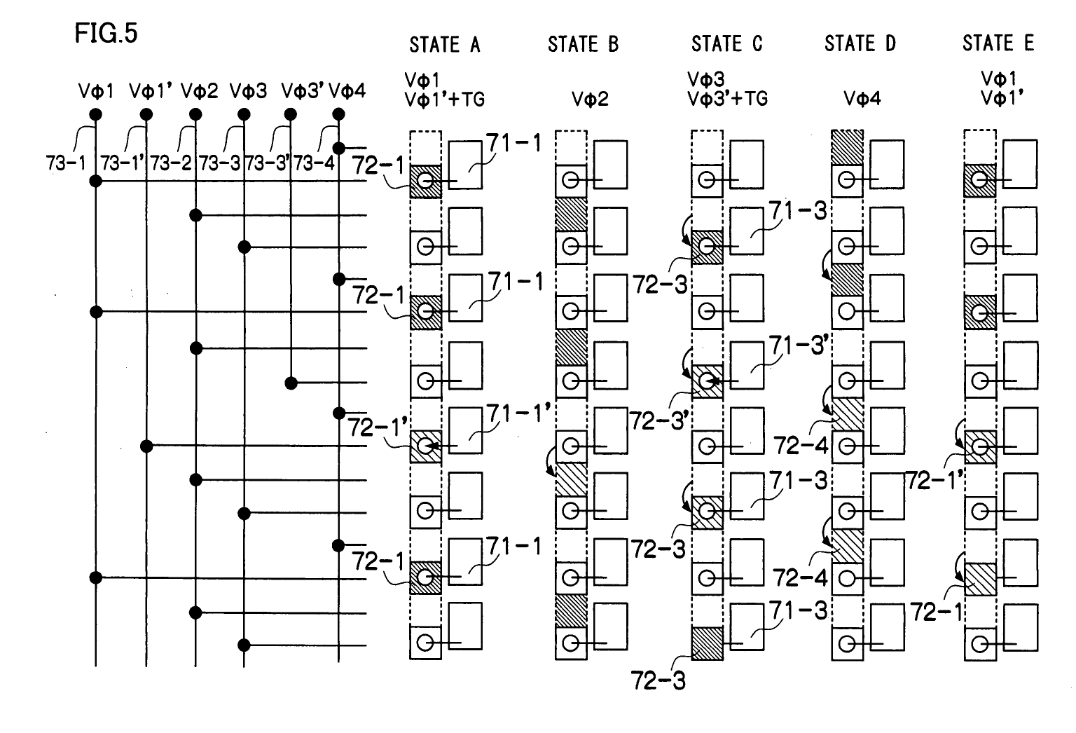

The operation of the CCD 45 in the specific line driving mode is described below with reference to FIG. 5.

First, when the bus line 73-1′ is supplied with an electric potential of level H (reading pulse TG), the electric charge of the photo diode 71-1′ are read out to the CCD 72-1′ (refer to state A in FIG. 5). In the next place, the electric charge is transferred downward by one step by the vertical transfer clock Vφ2 on the bus line 73-2 (refer to state B in FIG. 5). After that, the electric charges are transferred downward by one more step by the vertical transfer clocks Vφ3 and Vφ′ on the bus lines 73-3 and 73-3′. At this point, by supplying only the bus line 73-3′ with an electric potential of level H, the electric charge of the photo diode 71-3′ are read out to the CCD 72-3′ (refer to state C in FIG. 5). Subsequently, the electric charges are transferred downward by the vertical transfer clock Vφ4 on the bus line 73-4 (state D in FIG. 5) and the vertical transfer clocks Vφ1 and Vφ1′ on the bus lines 73-1 and 73-1′ (state E in FIG. 5). When the electric charges of the photo diodes 71-1′ and 71-3′ reach the horizontal transfer CCD 79, the horizontal transfer CCD is operated to read the electric charges of each of the vertical transfer CCDs. As described above, only the photo diodes 71-1′ and 71-3′ are read, so that the horizontal transfer CCD does not need operating until the electric charges reach the horizontal transfer CCD. Thus, it is enabled to read signal charges of the specific lines (or, a shooting slit area 81) at a high speed. The number of the specific lines is determined by the number of lines connected to the bus lines 73-1′ and 73-3′.

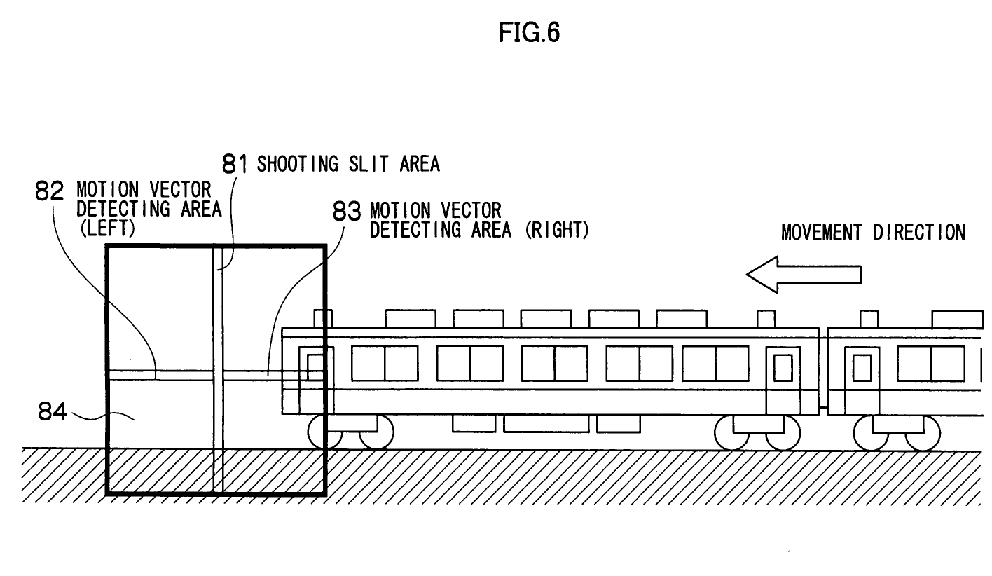

The shooting area of the CCD 45 at the time of slit shooting is described with reference to FIG. 6. FIG. 6 is a schematic diagram illustrating slit shooting and a train as an object which moves from the left to right on the drawing. Reference numeral 84 designates the entire shooting area of the CCD 45. FIG. 6 illustrates that an image is captured when the digital camera 10 is tilted by 90 degrees (that is, the camera is placed in portrait orientation). As described earlier, the digital camera 10 is capable of reading signal charges of part of the vertical transfer CCD (the shooting slit area 81) at a high speed, however, in this case, as the camera is tilted by 90 degrees, so that the shooting slit area 81 is vertical. The shooting slit area 81 is provided with a motion vector detecting area (left) 82 at its left side and a motion vector detecting area (right) 83 at its right side.

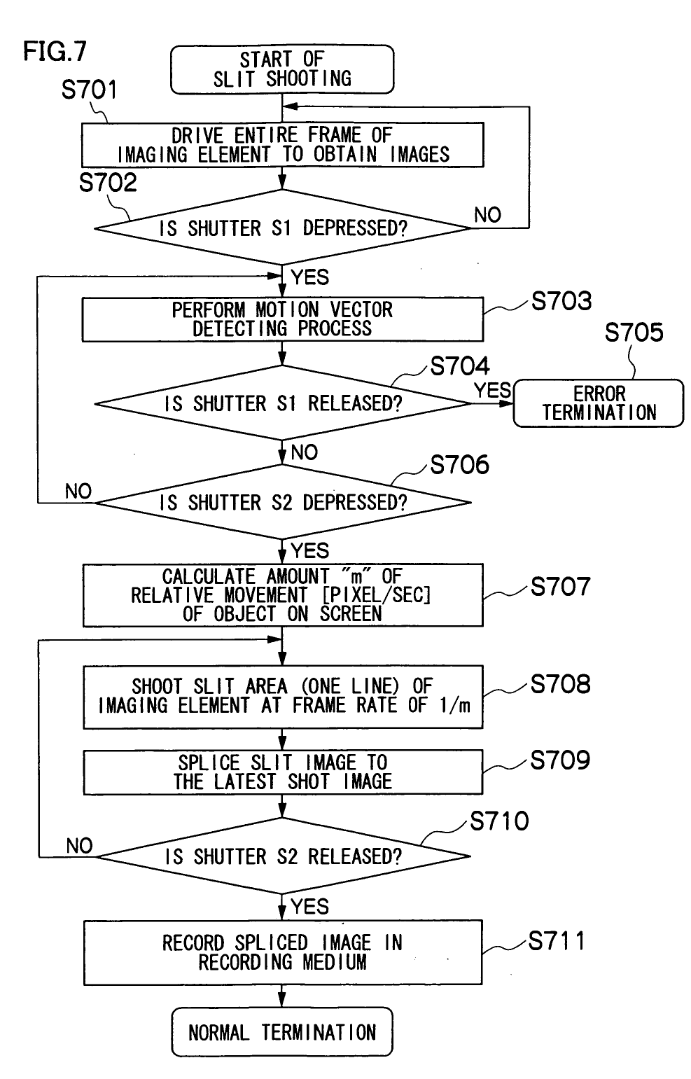

The operation of the slit shooting is described below with reference to FIG. 7. FIG. 7 is a flow chart illustrating the operation of the slit shooting.

When the camera is set to a mode for slit shooting, the driving system of the CCD 45 is set to the all pixel driving mode (step S701) and a determination is made as to whether the shutter button 13 is half-depressed (step S702). The camera is kept in the standby state until the shutter button 13 is half-depressed. When the shutter button is half-depressed, a motion vector detecting process is performed (step S703).

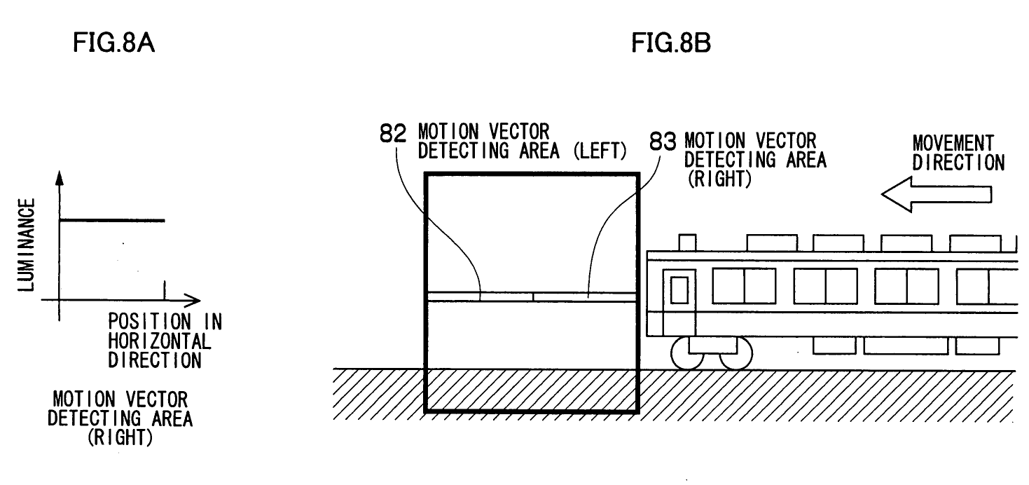

The motion vector detecting process is described below with reference to FIGS. 8A to 10B. The motion vector detecting process is such that continuous shooting is performed with the CCD set to an all pixel driving mode to cause the motion vector detecting circuit 61 to detect the motion vector of an object from change in luminance in the motion vector detecting area. FIGS. 8A to 10B illustrate schematic views for continuous shooting in the all pixel driving mode. FIGS. 8B, 9B and 10B show relationship between the shooting area 84 and the position of the object, and FIGS. 8A, 9A and 10A show the distribution of luminance in the motion vector detecting area (right) 83 at the time of FIGS. 8B, 9B and 10B respectively.

In FIGS. 8A and 8B, since the object does not exist in the shooting area 84, the distribution of luminance of the background is detected in the motion vector detecting area (right) as illustrated in FIG. 8A. Also in the motion vector detecting area (left), the luminance is detected.

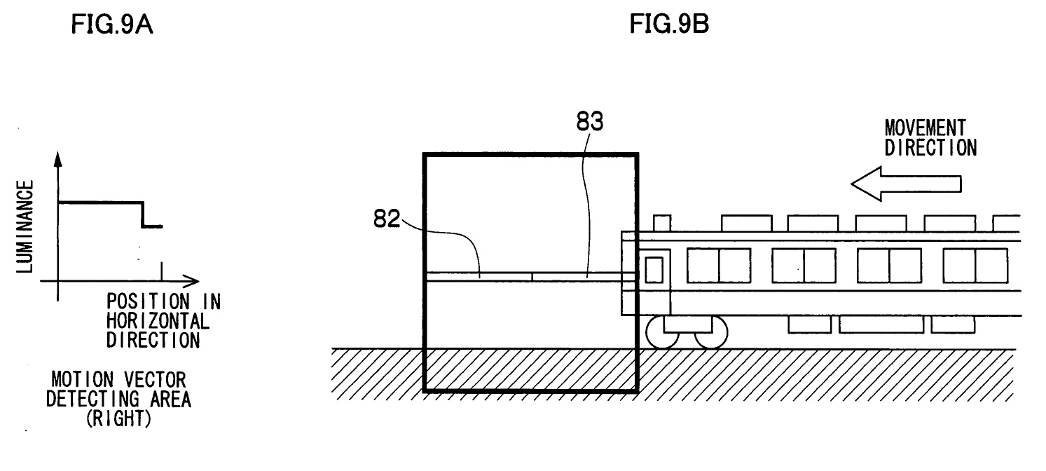

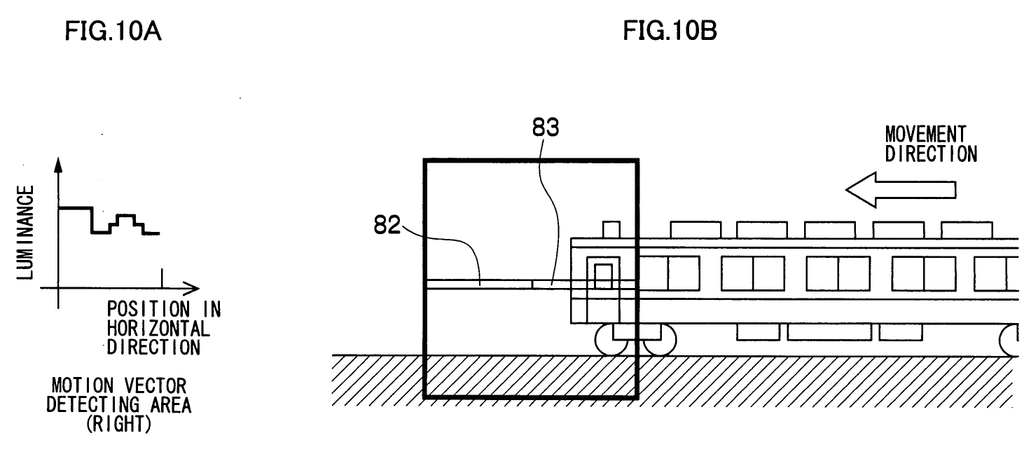

In FIGS. 9A and 9B, the object moves into the shooting area 84, the distribution of luminance of the object is detected in the motion vector detecting area (right) 83 as illustrated in FIG. 9A. In FIGS. 10A and 10B, the object further moves into the shooting area 84, the distribution of luminance of the object which has moved is detected in the motion vector detecting area (right) 83 as illustrated in FIG. 10A. Thus, the motion vector detecting circuit 61 detects the motion vector of the object from change in the luminance in the motion vector detecting area (right) 83 or the motion vector detecting area (left) 82.

When the motion vector detecting process at step S703 is finished, a determination is made as to whether the shutter button 13 is released (step S704). If the shutter button 13 is released, it is regarded that a user stops a shooting operation, and the operation is terminated without shooting (step S705). If the shutter button 13 is not released, a determination is made as to whether the shutter button 13 has been fully depressed (step S706). If the shutter button 13 has not been fully depressed, it is regarded that a half depression is continued and the process returns again to step S703 to continue the motion vector detecting process.

If the shutter button 13 has been fully depressed, the amount “m” of relative movement [PIXEL/SEC] of the object on the screen is calculated from the motion vector of the object detected by the motion vector detecting circuit 61 (step S707). Here, if a frame rate in the all pixel driving mode is taken to be “f” [PIXEL/SEC] and the number of movement pixels of an object between frames is taken to be “M” [PIXEL/FRAME], the amount “m” of relative movement of the object on the screen is calculated by the mathematical expression of: m=f×M.

After the amount “m” of relative movement of the object on the screen has been calculated, the driving system of the CCD 45 is changed over from the all pixel driving mode to the specific line driving mode. The shooting cycle (frame rate) of the slit shooting is calculated based on the calculated amount “m” of relative movement of the object on the screen. The shooting slit area 81 is formed only of one (1) line of the CCD 45 and the shooting period of the slit shooting is 1/m. For this reason, only the shooting slit area 81 is shot at a period of 1/m in the specific line driving mode (step S708). The shot image is spliced to the latest shot image (step S709) and a determination is made as to whether the shutter button 13 being fully-depressed is released (step S710). In the mode in which the slit shooting is performed, shooting is continued until the shutter button 13 being fully-depressed is released. If the shutter button 13 being fully-depressed is not released, the process returns to the step S708 to repeat performing the slit shooting and splicing of the shot images.

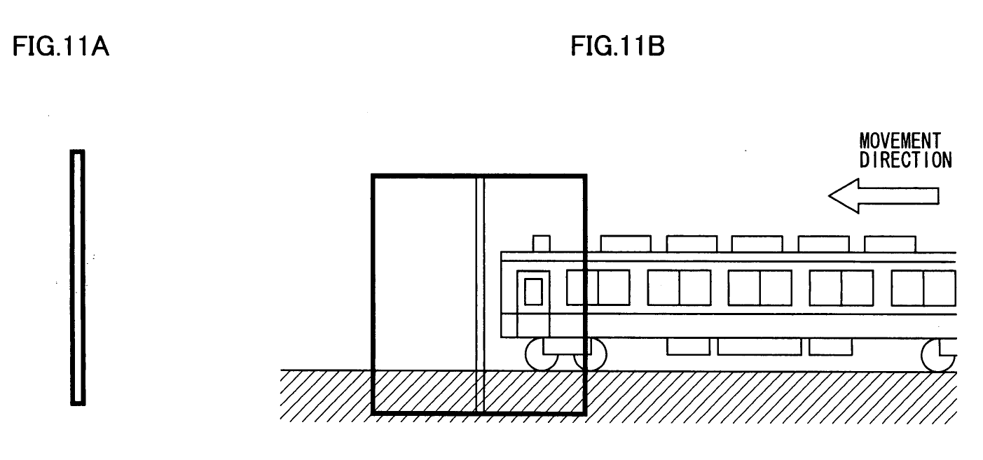

How to splice the shot images together is described below with reference to FIGS. 11A to 13B.

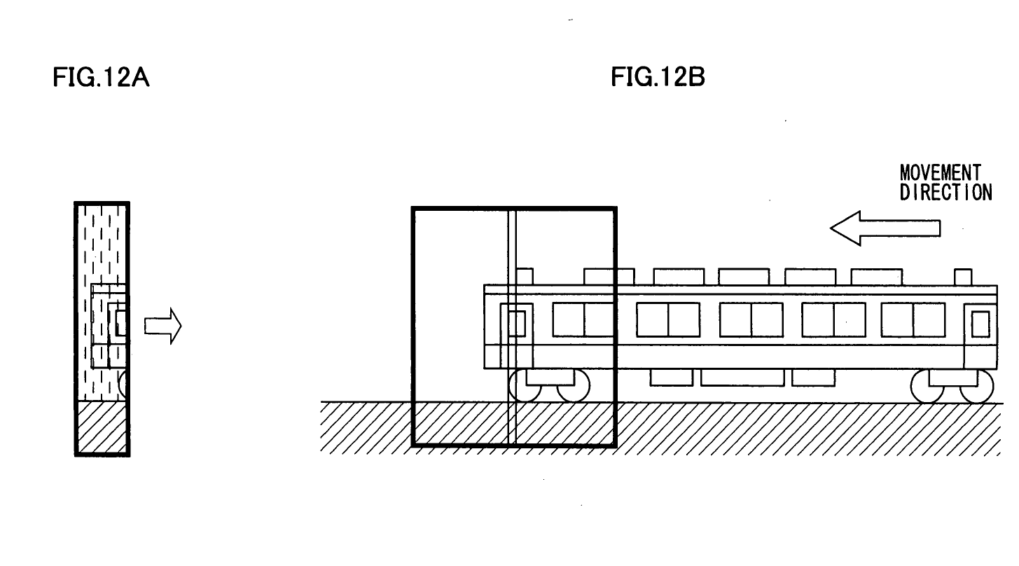

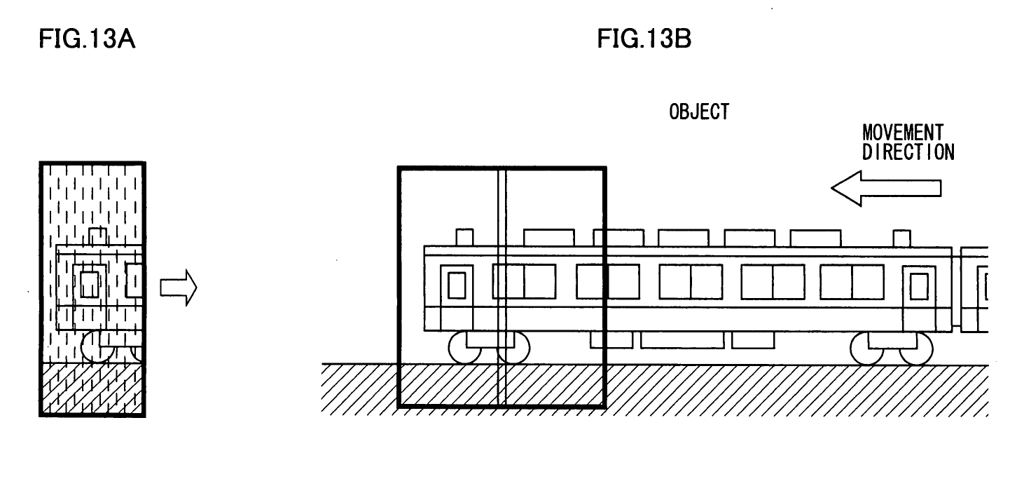

FIGS. 11A, 12A and 13A show positional relationship between the shooting area 84 and the position of the object, and FIGS. 11B, 12B and 13B show panoramic images in which the shot slit images are spliced together. FIGS. 11A and 11B are schematic views illustrating the first shoot after the shutter button 13 has been fully depressed. As described above, the shooting slit area 81 is formed of one (1) line of the CCD 45, so that the electric charges only on one (1) line are read out each time the shooting is performed. FIGS. 12A and 12B are schematic views illustrating the sixth shooting. As illustrated in FIG. 12A, the images for each shooting are separated by dotted lines for convenience sake. As illustrated in FIG. 12A, each shot images are spliced to the right side of the latest shot image, and thus six slit images are spliced together. FIGS. 13A and 13B are schematic views illustrating the 12th shooting with elapse of the time. As illustrated in FIG. 13A, the twelfth shot image is spliced to the right side of the eleventh shot image to enable a panoramic image to be produced.

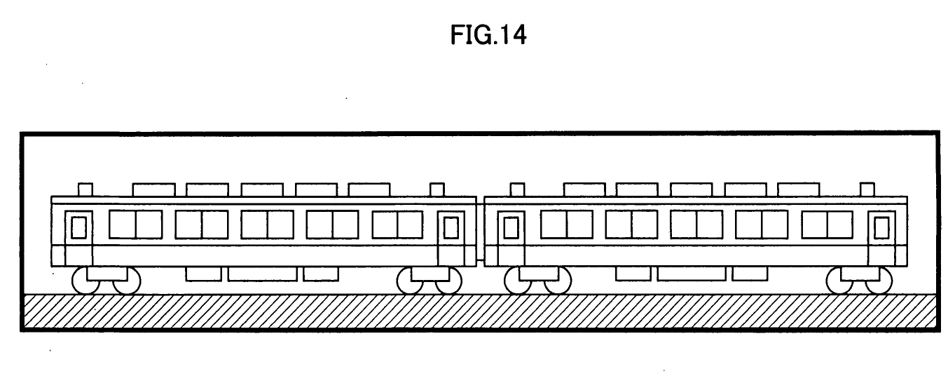

If it is determined that the shutter button 13 being fully-depressed is released at the step S710, the spliced images are recorded in the recording medium 38 (step S711) and then the shooting is terminated. FIG. 14 illustrates a long panoramic image in which all shot slit images are spliced together, recorded in the recording medium 38.

As stated above, the amount “m” of relative movement of the object on the screen is calculated from the frame rate in the all pixel driving mode and the number of moving pixels of an object between frames, shooting is performed at a cycle of 1/m in the specific line driving mode and the shot slit images are spliced together, thereby enabling producing a long panoramic image with a correct aspect ratio.

In the present embodiment, although the shooting slit area 81 is formed only of one (1) line of the CCD 45 and the slit shooting is performed by pixels on one (1) line in the specific line driving mode, this slit is not limited to one (1) line, but a plurality of lines may be used. Incidentally, if the shooting slit area 81 is formed of “n” lines, the shooting cycle of the slit shooting is n/m.

In the present embodiment, although a moving object is shot with the digital camera 10 fixed, a fixed object may be shot while the digital camera 10 is being moved. For example, scenery through the window of a train can be shot with the digital camera fixed on the side of window. In this case, also, the shooting cycle of the slit shooting is calculated from the amount of relative movement of an object and the images shot in this cycle are spliced together, thereby enabling producing a long panoramic image with a correct aspect ratio.

### Second Embodiment

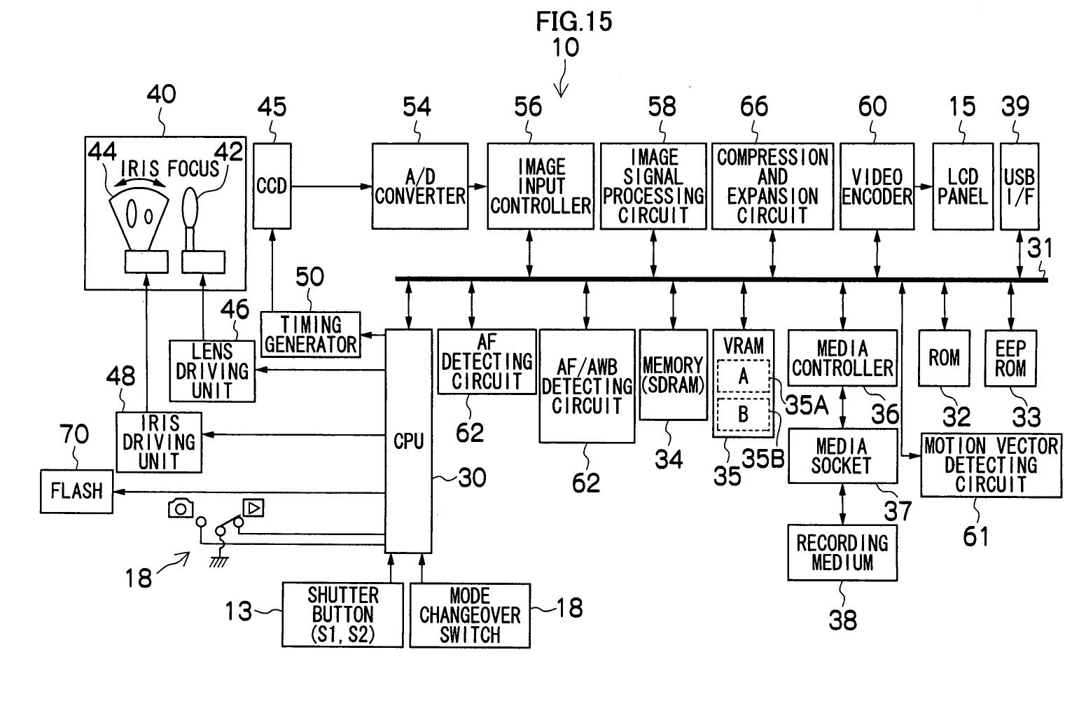

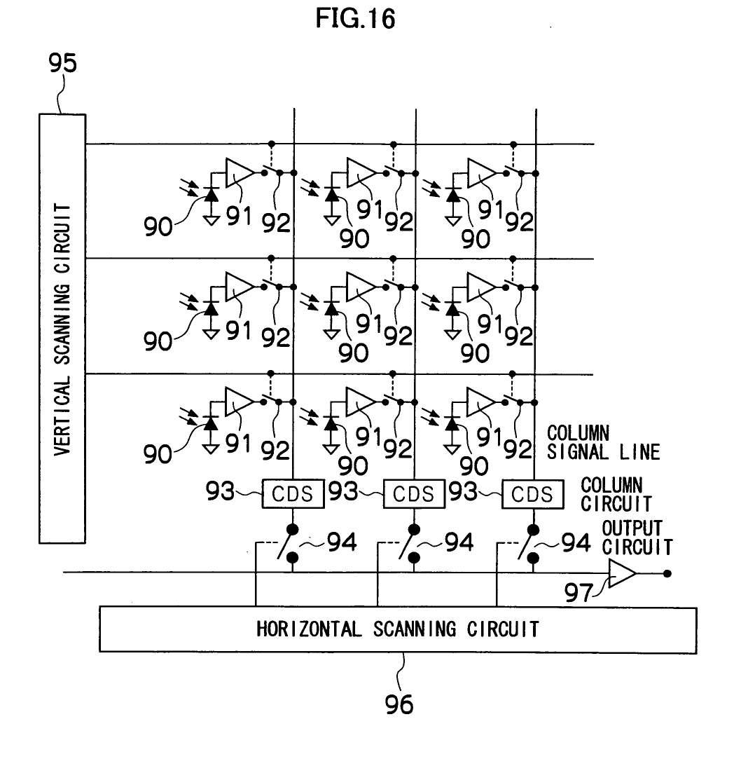

A digital camera 10 of a second embodiment according to the present invention is described with reference to FIGS. 15 and 16. FIG. 15 is a block diagram illustrating the internal configuration of the digital camera 10 of the second embodiment. The block diagram in FIG. 15 is different from that of the digital camera 10 of the first embodiment illustrated in FIG. 2 in that a CMOS 51 is used in the area sensor instead of the CCD 45. The circuit corresponding to the CDS/AMP circuit 52 is included in the CMOS 51, so that it is omitted from the block diagram.

FIG. 16 is a schematic diagram of the CMOS 51. Electric charges photo-electrically converted by a photo diode 90 are amplified by an amplifying circuit 91. Out of switches 92 on the output side of the amplifying circuits 91, only the switch 92 that is selected by a vertical scanning circuit 95 is turned on. When a selected switch 92 is turned on, a CDS circuit 93 applies correlated double sampling process to the output of the amplifying circuit 91. Out of the signals, only the signal that is selected by a horizontal scanning circuit 96 is input to an output circuit 97.

The vertical scanning circuit 95 scans all pixels in the vertical direction and the horizontal scanning circuit 96 scans all pixels in the horizontal direction to allow all pixels to be scanned. The output of the vertical scanning circuit 95 is fixed only to the specific line and the horizontal scanning circuit 96 scans all pixels in the horizontal direction, which enables to read out only pixels on specific one (1) line in the horizontal direction. On the other hand, the output of the horizontal scanning circuit 96 is fixed only to the specific line and the vertical scanning circuit 95 scans all pixels in the vertical direction, which enables to read out only pixels on specific one (1) line in the vertical direction.

Thus, the digital camera 10 of the second embodiment is capable of setting the shooting slit area 81 both in the vertical line and in the horizontal line. This does not need to tilt the camera by 90 degrees unlike the first embodiment at the time of producing a panoramic image by slit shooting, that is to say, it is enabled to obtain a similar image with the camera in its normal attitude.

The operation of the slit shooting is the same as in the first embodiment, so that a description thereof is omitted.

### Third Embodiment

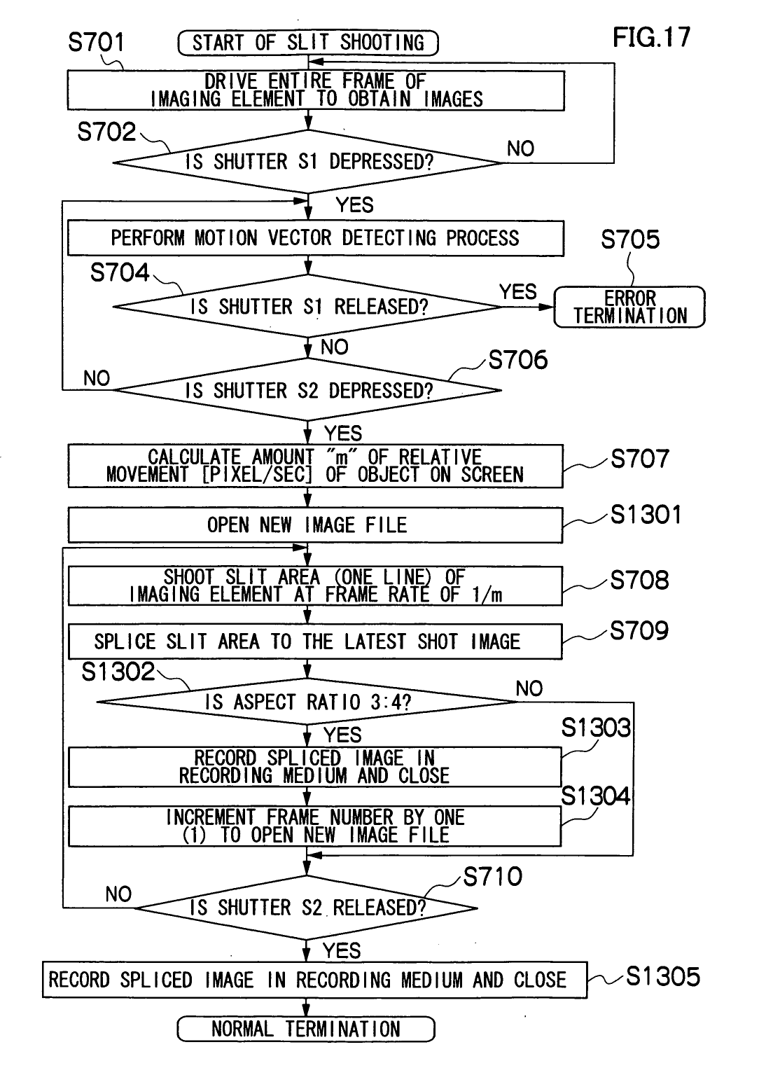

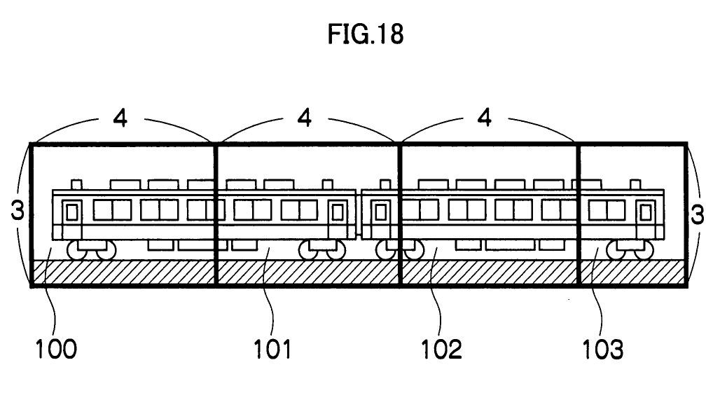

A digital camera 10 of a third embodiment according to the present invention is described with reference to FIGS. 17 and 18. The digital camera 10 of the third embodiment divides a long panoramic image in which slit images are spliced together into a plurality of image files and records them.

FIG. 17 is a flow chart illustrating the operation of the digital camera 10 of the third embodiment. The portions common to those in the first embodiment illustrated in FIG. 7 are designated by the same reference numerals and characters and the detailed description thereof is omitted.

As is the case with the first embodiment, half-depressing the shutter button 13 in the slit shooting mode causes the camera to perform the motion vector detecting process. Thereafter, fully-depressing the shutter button 13 causes the camera to calculate the amount “m” of relative movement of the object on the screen based on the motion vector (steps S701 to S707).

In the next place, a new image file is opened to record the slit image (step S1301).

As is the case with the first embodiment, only the specific one (1) line on the imaging element is shot in 1/m cycle (step S708) based on the calculated amount “m” of relative movement of the object on the screen and the shot image is spliced to the latest shot image (step S709).

Assuming the LCD panel 15 of the digital camera 10 has an aspect ratio of 3:4, a determination is made as to whether the aspect ratio of the spliced images is 3:4 that is the aspect ratio of the LCD panel 15 (step S1302). If the aspect ratio is not 3:4, a determination is made as to whether the shutter button 13 is released (step S710). If the aspect ratio is 3:4, the spliced images are recorded in the recording medium, the image file is closed (step S1303), and a frame number is incremented by one (1) to open a new image file (step S1304), thereafter, a determination is made as to whether the shutter button 13 is released (step S710).

If the shutter button 13 is not released, the process returns to the step S708 to continue shooting. If the shutter button 13 is released, the remaining spliced images are recorded in the recording medium 38, the image file is closed (step S1305) and the slit shooting is terminated.

FIG. 18 is a schematic view illustrating the shot long panoramic image. The image is recorded in the recording medium 38 as another image file every time the aspect ratio of the spliced image reaches 3:4. In FIG. 18, the long panoramic image is separated into a first image 100, a second image 101, a third image 102 and a fourth image 103. As stated above, the LCD panel 15 of the digital camera 10 has an aspect ratio of 3:4 and is capable of dividing the long panoramic image into the first image 100, the second image 101, the third image 102 and the fourth image 103 and reproducing them. Thus, dividing the panoramic image into images having the same aspect ratio as the LCD panel 15 being the reproduction display device of the digital camera 10 and recoding them enable the images to be reproduced as is the case with a normal image, which does not need a specific reproduction mode.

In addition, thus dividing the panoramic image causes each image to be the same in size as a normal image, so that it can be treated similarly to the normal image at the time of compressing and recording the file of the image, which eliminates the need for a special processing.

Incidentally, the aspect ratio to be divided may be 2:3 that is the aspect ratio of L size print or may be 9:16 that is the aspect ratio of the Hi-Vision system.

A series of the panoramic image may be recorded with an Exif tag when the long panoramic image is divided and stored as another file. This permits a plurality of image groups to be spliced together by a dedicated software to reproduce or print it as a long panoramic image.

A series of the images may be spliced from the record of the Exif tag to reproduce it by a scroll display when the long panoramic image is reproduced by the digital camera 10.

### Fourth Embodiment

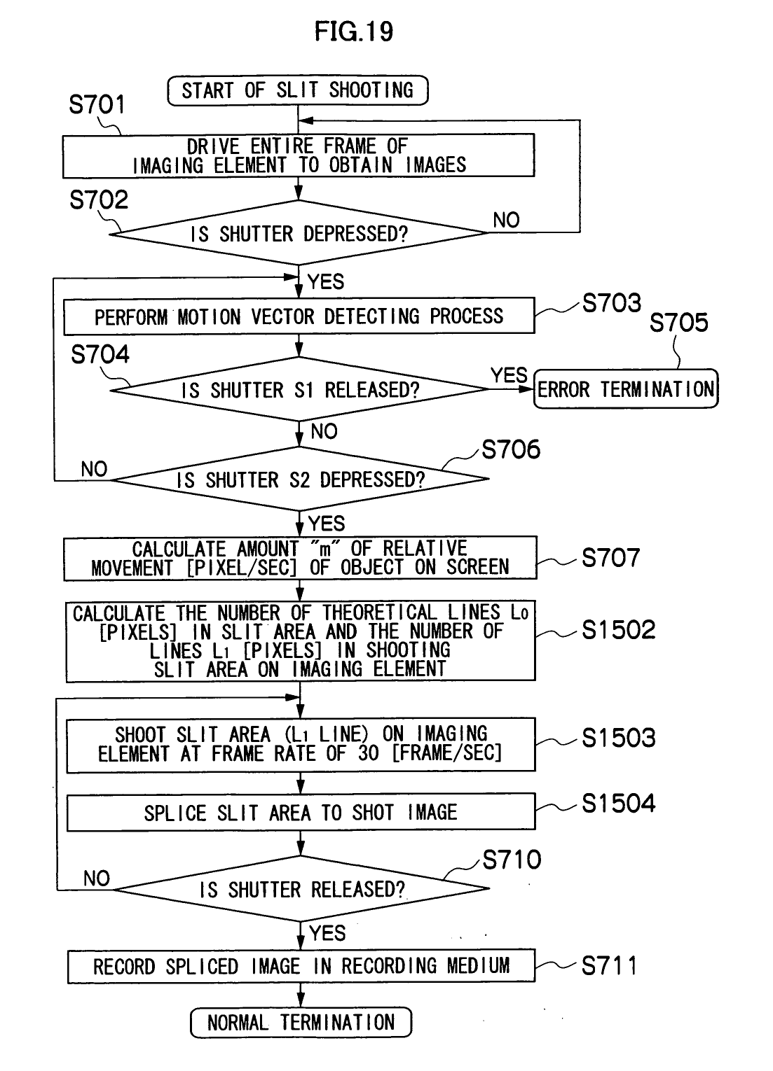

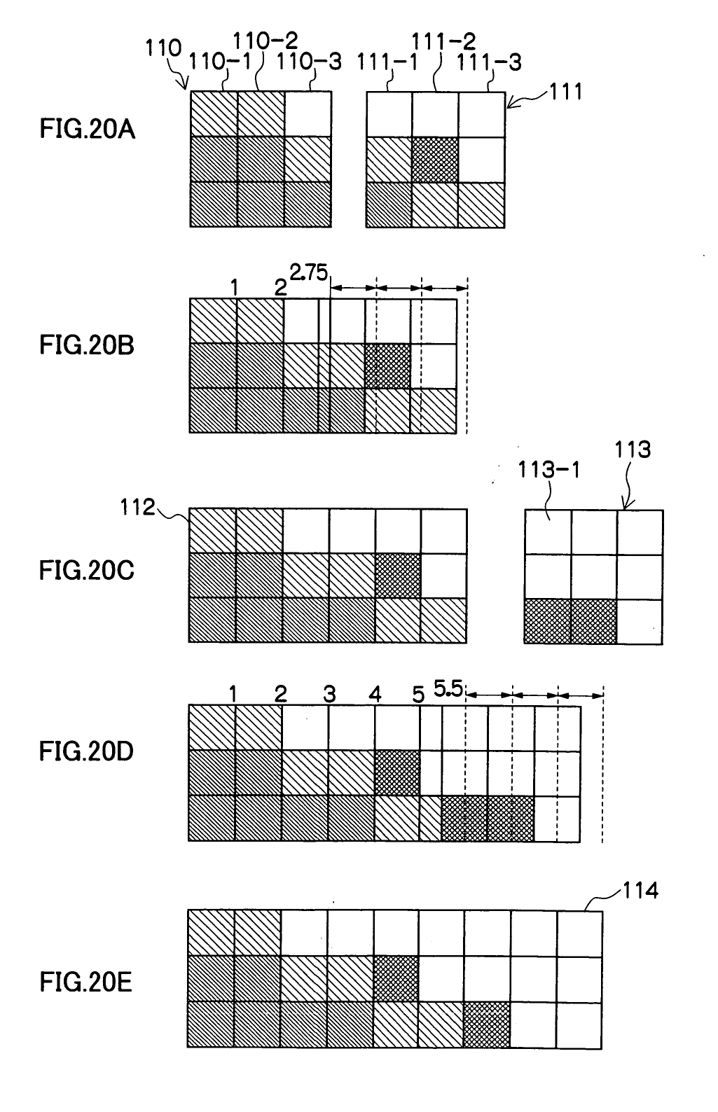

A digital camera 10 of a fourth embodiment according to the present invention is described with reference to FIGS. 19, 20A, 20B, 20C, 20D and 20E. The digital camera 10 of the fourth embodiment does not have the mode for reading only the pixels on the specific line unlike the first embodiment, performs a continuous shooting in the all pixel driving mode and splices data at a slit portion at the center of an image to produce a long panoramic image.

FIG. 19 is a flow chart illustrating the operation of the digital camera 10 of the fourth embodiment. The portions common to those in the first embodiment in FIG. 7 are designated by the same reference numerals and characters and the detailed description thereof is omitted.

As is the case with the first embodiment, half-depressing the shutter button 13 in the slit shooting mode causes the camera to perform the motion vector detecting process. Thereafter, fully-depressing the shutter button 13 causes the camera to calculate the amount “m” of relative movement of the object on the screen based on the motion vector (steps S701 to S707).

In the next place, the number of theoretical lines Lₒ [PIXELS] in the slit area and the number of lines Lₗ [PIXELS] in the shooting slit area on the imaging element are calculated based on the shooting cycle (frame rate) in the all pixel driving mode and the amount “m” of relative movement of the object on the screen (step S1502). If the shooting cycle (frame rate) is 30 [Frame/SEC] and the amount of relative movement is 82.5 [PIXEL/SEC], the number of theoretical lines in the slit area is Lₒ=82.5/30=2.75 [PIXELS]. The number of lines Lₗ in the shooting slit area is 3 [PIXELS] to which places after the decimal point of the number of theoretical lines Lₒ in the slit area are rounded up.

After the calculation has been finished, shooting is performed in the all pixel driving mode (step S1503). The signal charges of all pixels are read, however, only data on the number of lines Lₗ in the shooting slit area determined at the step S1502 is used as shooting data. Incidentally, a substantial center area of the screen is selected as the shooting area.

Next, the images on the number of lines Lₗ in the shooting slit area determined at the step S1502 are spliced together (step S1504).

How to splice the images together is described below with reference to FIGS. 20A, 20B, 20C, 20D and 20E. FIGS. 20A, 20B, 20C, 20D and 20E are schematic diagrams illustrating the process for splicing the images together. The slit image is originally lengthwise, however, images in the lengthwise direction are omitted and only three [PIXELS] are shown. FIG. 20A illustrates the first shot slit image 110 and the secondly shot slit image 111. As mentioned above, the number of lines Lₗ in the shooting slit area is three (3), so that shooting is performed three [PIXELS] each. The number of theoretical lines Lₒ in the slit area is 2.75 [PIXELS], so that the portion 0th (left end) [PIXEL] of the secondly shot slit image 111 is superposed on the portion 2.75th (viewed from the left end) [PIXEL] of the first shot slit image 110 as illustrated in FIG. 20B.

Next, the luminance and color of each pixel are calculated. The luminance and color of each pixel is calculated from the ratio of adjacent pixels. For the luminance and color of the pixels on the third column viewed from the left end of the spliced image, the composition ratio is as follows: the pixels on the right column 110-3 of the first shot image 110 account for 0.75 (75%); and the pixels on the left column 111-1 of the second shot image 111 account for 0.25 (25%). Thus, the luminance and color of the pixels on the third column viewed from the left end in the spliced image are calculated based on this ratio.

In addition, for luminance and color of the pixels on the fourth column viewed from the left end of the spliced image, the composition ratio is as follows: the pixels on the left column 111-1 of the second shot image 111 account for 0.75 (75%); and the pixels on the center column 111-2 of the second shot image 111 account for 0.25 (25%). Thus, the luminance and color of the pixels on the fourth column viewed from the left end in the spliced image are calculated based on this ratio. Similarly, for luminance and color of the pixels on the fifth column viewed from the left end of the spliced image, the composition ratio is as follows: the pixels on the center column 111-2 of the second shot image 111 account for 0.75 (75%); and the pixels on the right column 111-3 of the second shot image 111 account for 0.25 (25%). Thus, the luminance and color of the pixels on the fifth column viewed from the left end in the spliced image are calculated based on this ratio.

For luminance and color of the pixels on the right end column (on the sixth column viewed from the left end) of the spliced image, as a third shooting is not performed yet, pixels to be superposed on the pixels on the right end column are not exist. Therefore, the pixels on the right end column are not superposed until the third shooting is performed. The luminance and color which are the nearest among thus calculated luminance and color are taken to be the luminance and color of the pixel.

FIG. 20C illustrated an image 112 in which the first shot slit image 110 is spliced to the second shot slit image 111 based on the determined luminance and color. Reference numeral 113 designates the third shot slit image. The third shot slit image is also spliced.

As illustrated in FIG. 20D, the spliced image 112 is superposed on the third shot slit image 113. In this case, the portion of 5.5 (=2.75×2)th [PIXEL] of the spliced image 112 is superposed on the portion of 0th [PIXEL] of the third shot slit image 113.

Sequentially, the luminance and color of each pixel is calculated. The luminance and color which are nearest among the calculated luminance and color are taken to be the luminance and color of the pixel. For example, similarly to the above, the luminance and color of the pixels on the sixth column viewed from the left on the spliced image, the composition is as follows: the pixels on the right column 111-3 of the second shot image 111 account for 0.5; and the pixels on the left column 113-1 of the third shot image 113 account for 0.5. Thus, the luminance and color of the pixels on the sixth column viewed from the left end in the spliced image are calculated based on this ratio.

The luminance and color of the pixels on the seventh column and eighth column viewed from the left on the spliced image are also calculated in a similar way. The pixels on the right end column (ninth column viewed from the left end) on the spliced image are not superposed until the fourth shooting is performed. FIG. 20E illustrated an image 114 in which the spliced image 112 is spliced to the third shot slit image 113.

A determination is made as to whether the shutter button 13 is released (step S710). This process is repeated until the shutter button 13 is released. When slit images are spliced together, the slit images are superposed by the amount of the difference between the number of theoretical lines in the slit area Lₒ and the number of lines Lₗ in the shooting slit area. Therefore, every time slit images are superposed and spliced together, the spliced image is displaced in column-wise by the amount of the difference.

Here, in this example, every time slit images are spliced together, the spliced image is displaced (shifted) in column-wise by 0.25 pixel. Therefore, the spliced image is displaced by 1 (one) pixel in column-wise every four splice operation. For example, after the fifth shot slit image is spliced to the fourth shot slit image (after the fourth splice operation), the spliced image obtained after the fourth splice operation is displaced by 1 (one) pixel in column-wise, and the total number of columns of pixels constituting the spliced image becomes 14 (3×5−1=14) [PIXELS].

In this way, slit images are properly spliced together even when the number of theoretical lines in the slit area Lₒ and the number of lines Lₗ in the shooting slit area are different from each other. If the shutter button 13 is released, the spliced images are recorded in the recording medium 38 and the slit shooting is terminated.

Thus, even if the digital camera 10 does not have the mode for reading only the pixels on the specific line, a shooting is performed in the entire face driving mode and the images at slit portions are spliced together to enable a long panoramic image to be produced.

### Fifth Embodiment

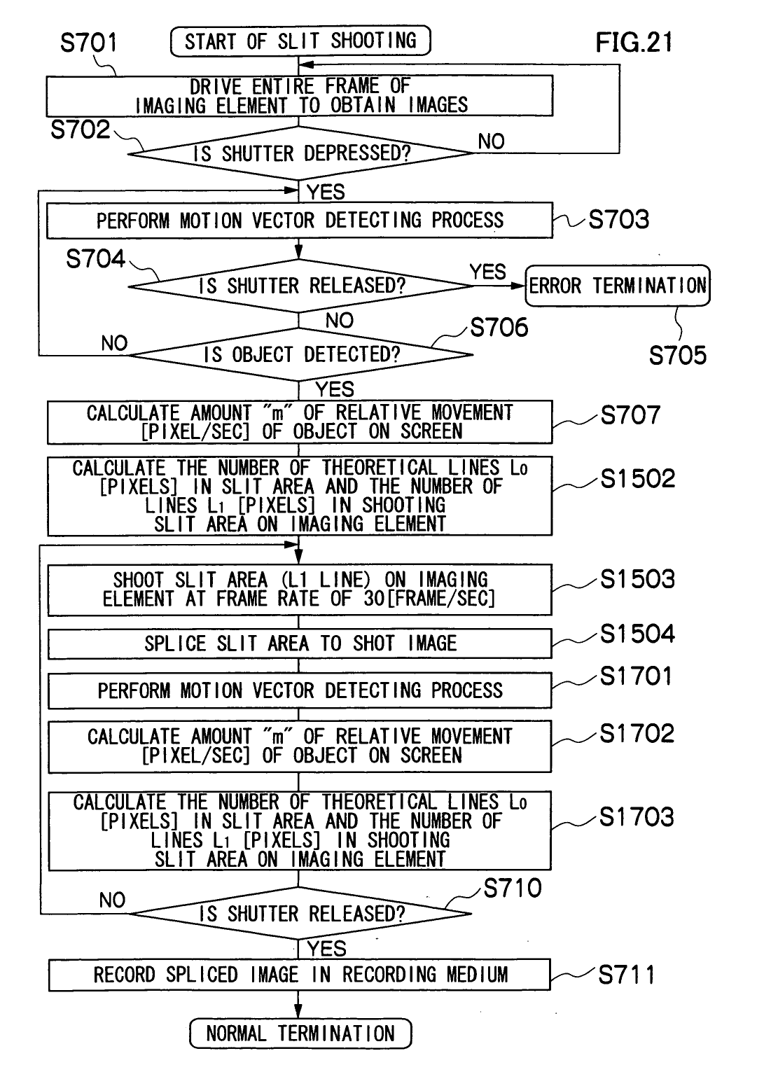

A digital camera 10 of a fifth embodiment according to the present invention is described with reference to FIG. 21. The digital camera of the fifth embodiment performs a slit shooting in the all pixel driving mode as is the case with the fourth embodiment and detects the motion vector of an object every time the slit shooting is performed to change the number of lines in the shooting slit area according to the acceleration of the object.

FIG. 21 is a flow chart illustrating the operation of the digital camera 10 of the fifth embodiment. The portions common to those in the fourth embodiment illustrated in FIG. 19 are designated by the same reference numerals and characters and the detailed description thereof is omitted.

As is the case with the fourth embodiment, half-depressing the shutter button 13 in the slit shooting mode causes the camera to perform the motion vector detecting process. Thereafter, fully-depressing the shutter button 13 causes the camera to calculate the amount “m” of relative movement of the object on the screen based on the motion vector (steps S701 to S707).

In the next place, the number of theoretical lines Lₒ in the slit area and the number of lines Lₗ in the shooting slit area on the imaging element are calculated based on the amount “m” of relative movement of the object on the screen (step S1502). As is the case with the fourth embodiment, the number of theoretical lines Lₒ in the slit area is taken to be 2.75 [PIXELS]. The number of lines Lₗ in the shooting slit area is taken to be 3 [PIXELS].

After that, a shooting is performed in the all pixel driving mode (step S1503). The images on the number of lines Lₗ in the shooting slit area determined at the step S1503 are spliced together (step S1504). How to splice them together is also the same as in the fourth embodiment.

After splicing has been finished, the motion vector detecting process is performed again (step S1701). The motion vector detecting process is the same as that at the step S703. The amount “m” of relative movement of the object is calculated again based on the determined motion vector (step S1702) and the number-of theoretical lines Lₒ in the slit area and the number of lines Lₗ in the shooting slit area on the imaging element are calculated (step S1703). Then, if the amount “m” of relative movement of the object to which an acceleration is applied is 93 [PIXEL SEC], the number of theoretical lines in the slit area is Lₒ=93/30=3.1 [PIXELS] and the number of lines in the shooting slit area is Lₗ=4 [PIXELS].

After these calculations have been finished, a determination is made as to whether the shutter button 13 is released (step S710). If the shutter button 13 is not released, shooting is performed again in the all pixel driving mode (step S1503). Then, the images on the number of lines Lₗ in the shooting slit area newly determined here are spliced together (step S1504). How to splice them together is also the same as in the above embodiments, but the process is performed using the newly obtained number of theoretical lines Lₒ in the slit area and the number of lines Lₗ in the shooting slit area, that is, Lₒ=3.1 [PIXELS] and Lₗ=4 [PIXELS]. That is to say, the portion 0th (left end) [PIXEL] of the secondly shot slit image is superposed on the portion 2.75th [PIXEL] of the first shot slit image to calculate the luminance and color of each pixel. For the next shot, the portion 0th (left end) [PIXEL] of the slit image shot next is superposed on the portion 2.75+3.1=5.85th [PIXEL] of the spliced image to calculate the luminance and color of each pixel.

After splicing has been finished, the motion vector detecting process is performed again. The amount “m” of relative movement of the object, the number of lines Lₒ in the shooting slit area and the number of theoretical lines Lₗ in the shooting slit area are calculated. A shooting is repeated until the shutter button 13 is released.

If the shutter button 13 is released, the spliced images are recorded in the recording medium 38 and the shooting is terminated.

Thus, every time a slit shooting is performed, the motion vector of an object for each slit shooting is detected to determine the amount of relative movement of the object on the screen based on the motion vector, and the slit width to be shot is calculated based on the amount of the relative movement. Thereby enabling producing a long panoramic image with a correct aspect ratio even if an acceleration is applied to the object to be shot.

In the present embodiment, although a shooting is performed such that the number of lines Lₗ in the shooting slit area is adjusted according to change in the motion vector of an object, a shooting cycle of the slit shooting may be adjusted in the digital camera 10 having the mode for reading only the pixels on the specific line as in the first embodiment. That is to say, the motion vector of an object for each slit shooting is detected to determine the amount of relative movement of the object on the screen based on the motion vector, and the shooting cycle in the shooting slit area 81 is calculated based on the amount of the relative movement. Thus, it is possible to produce a long panoramic image with a correct aspect ratio even if an acceleration is applied to the object.

### Sixth Embodiment

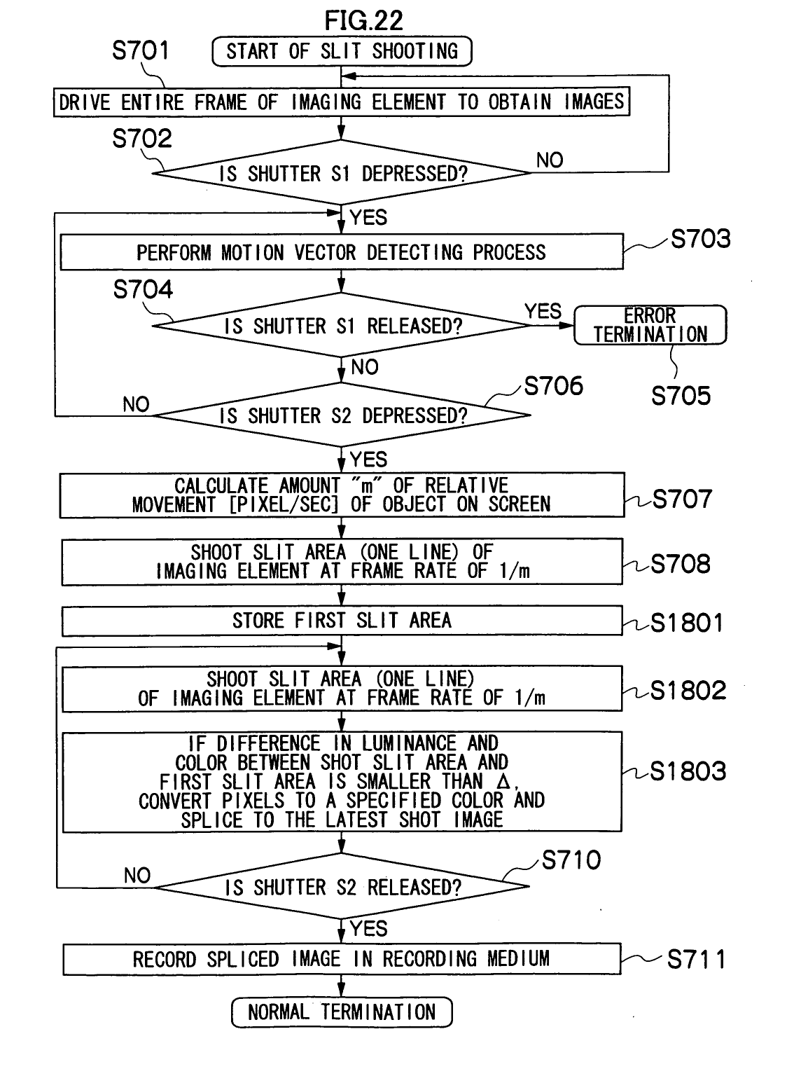

A digital camera 10 of a sixth embodiment according to the present invention is described with reference to FIGS. 22, 23A, 23B, 24A, 24B, 25A, 25B and 26. The digital camera of the sixth embodiment performs a slit shooting in the mode for reading only the pixels on the specific line as in the first embodiment and provides a long panoramic image with a background tinted (filled) with a predetermined color.

FIG. 22 is a flow chart illustrating the operation of the digital camera 10 of the sixth embodiment. The portions common to those in the first embodiment in FIG. 7 are designated by the same reference numerals and characters and the detailed description thereof is omitted.

As is the case with the first embodiment, half-depressing the shutter button 13 in the slit shooting mode causes the camera to perform the motion vector detecting process. Thereafter, fully-depressing the shutter button 13 causes the camera to calculate the amount “m” of relative movement of the object on the screen based on the motion vector (steps S701 to S707).

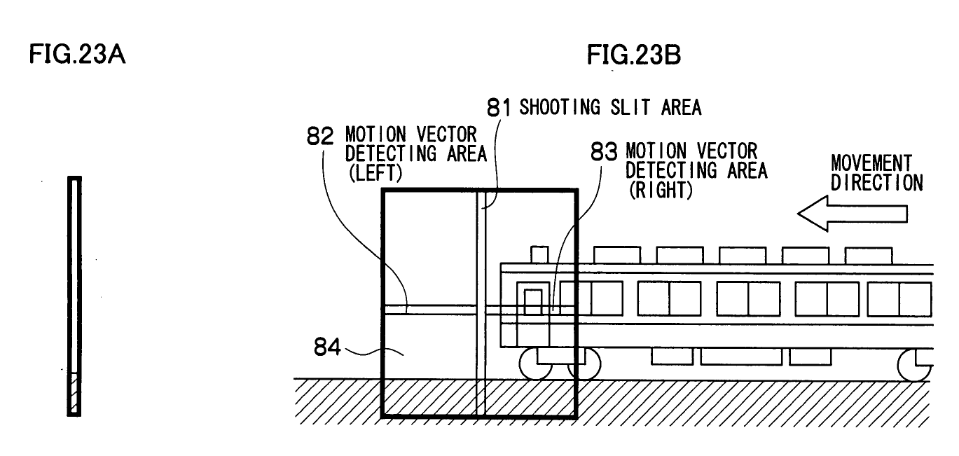

A shooting is performed in 1/m cycle (step S708), and the first shot slit image is recorded here (step S1801). FIG. 23A shows the first shot slit image. FIG. 23B shows a relationship between the shooting area 84 in this shooting and the position of the object.

The next slit image is shot after 1/m seconds (step S1802). Here, a difference in luminance and color between the currently shot slit image and the recorded first shot slit image is determined. The pixels in which the difference is smaller than a predetermined value are regarded as background and converted to a specified color (for example, white) (step S1803).

A determination is made as to whether the shutter button 13 is released (step S710). If the shutter button 13 is not released, the process returns to the step S1802 to perform shooting again in 1/m cycle. Similarly, a difference in luminance and color between the shot slit image and the stored first shot slit image is determined. The pixels in which the difference is smaller than a predetermined value are converted to white and then the shot slit image is spliced to the latest shot image. This is repeated until the shutter button 13 is released.

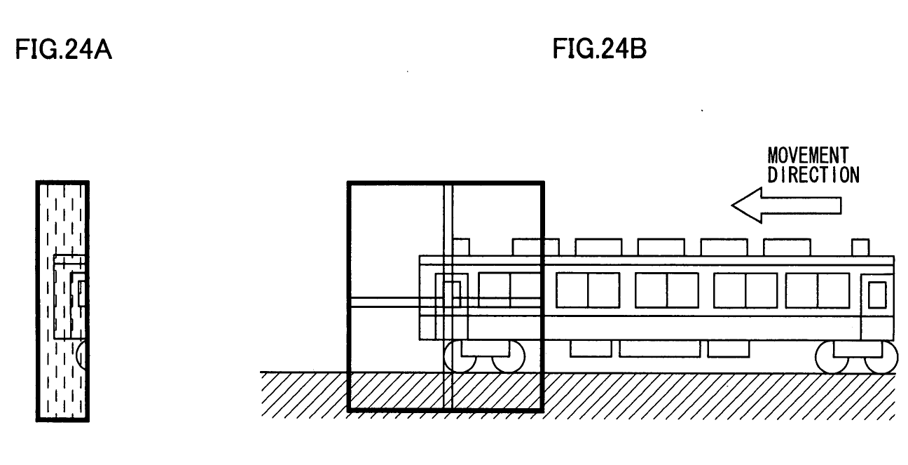

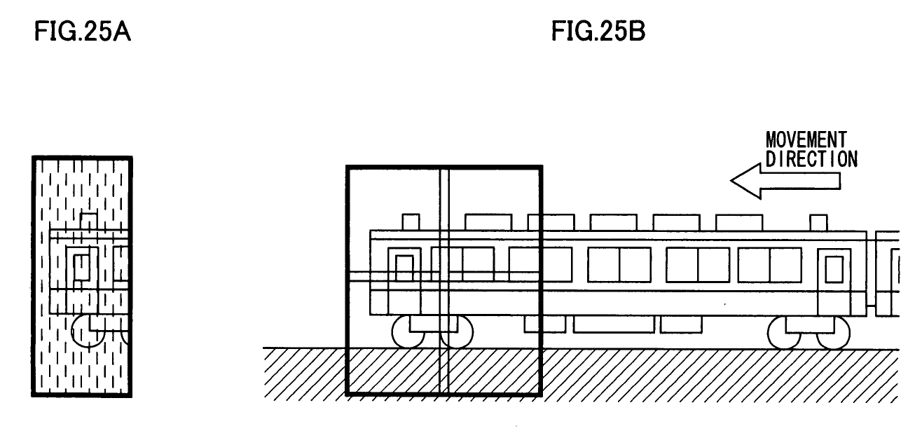

FIG. 24A is a schematic view in which the slit shooting is performed six times and the six slit images are spliced together. FIG. 24B is a schematic view illustrating a relationship between the shooting area 84 in this shooting and the position of the object. FIG. 25A is a schematic view in which the slit shooting is performed 12 times and the 12 slit images are spliced together. FIG. 25B is a schematic view illustrating a relationship between the shooting area 84 in this shooting and the position of the object. As can be seen from FIGS. 24A, 24B, 25A and 25B, the ground on the spliced images is converted to white and only the object is shot.

If the shutter button 13 is released, the spliced images are recorded in the recording medium 38 (step S711) and the shooting is terminated (step S711).

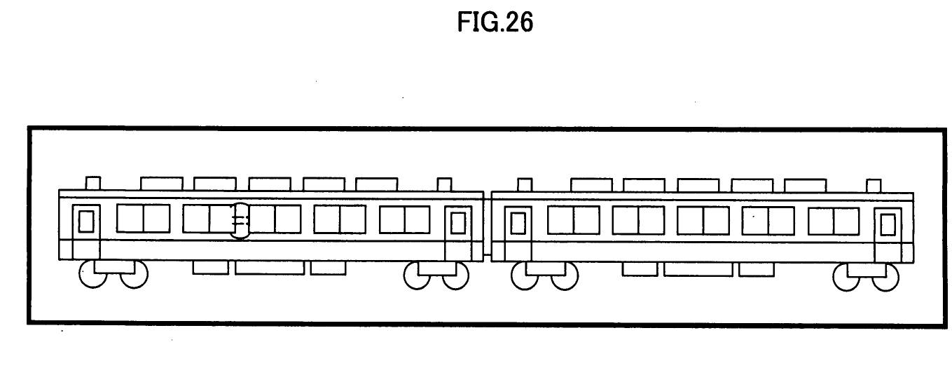

FIG. 26 is a long panoramic image in which all shot images are spliced together. As can be seen from the figure, the ground is totally converted to white and only the object is shot.

Thus, the image before the object passes is recorded and a difference in luminance and color between the shot image, the recorded image is determined, and the pixels in which the difference is smaller than a predetermined value are converted to a specified color to remove unnatural background, thereby producing a long panoramic image only with an object.

### Seventh Embodiment

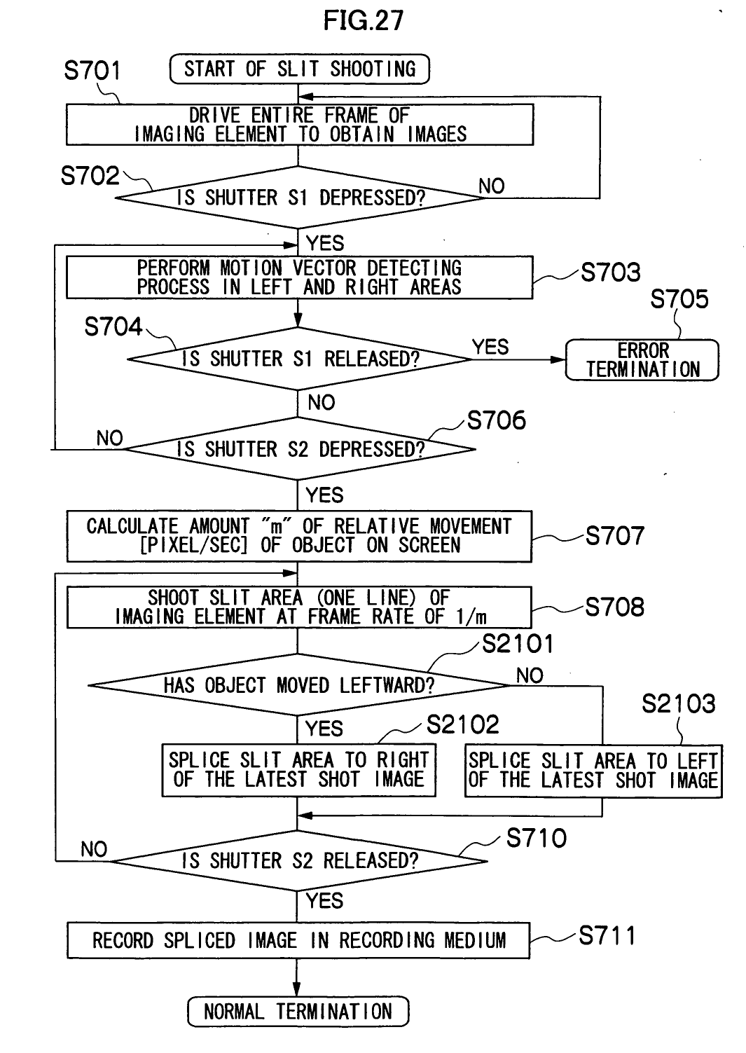

A digital camera 10 of a seventh embodiment according to the present invention is described with reference to FIGS. 27, 28A, 28B, 29A and 29B. The digital camera of the seventh embodiment performs a slit shooting in the mode for reading only the pixels on the specific line as in the first embodiment, and the direction in which an object moves is determined to determine the direction in which the shot slit images are spliced together.

FIG. 27 is a flow chart illustrating the operation of the digital camera 10 of the seventh embodiment. The portions common to those in the first embodiment in FIG. 7 are designated by the same reference numerals and characters and the detailed description thereof is omitted.

As is the case with the first embodiment, half-depressing the shutter button 13 in the slit shooting mode causes the camera to perform the motion vector detecting process. Thereafter, fully-depressing the shutter button 13 causes the camera to calculate the amount “m” of relative movement of the object on the screen based on the motion vector (steps S701 to S707).

A shooting is performed in 1/m cycle (step S708). A determination is made from the motion vector determined at the step S703 as to whether the object moves leftward or rightward on the screen (step S2101). If the object moves leftward, the slit image is spliced to the right side of the latest shot image (step S2102). If the object moves rightward, the slit image is spliced to the left side of the latest shot image (step S2103).

A determination is made as to whether the shutter button 13 being fully-depressed is released. If the shutter button 13 is not released, the slit shooting is continued in 1/m cycle (step S708). If the shutter button 13 being fully-depressed is released, the spliced images are recorded in the recording medium 38 (step S711) and the shooting is terminated (step S711).

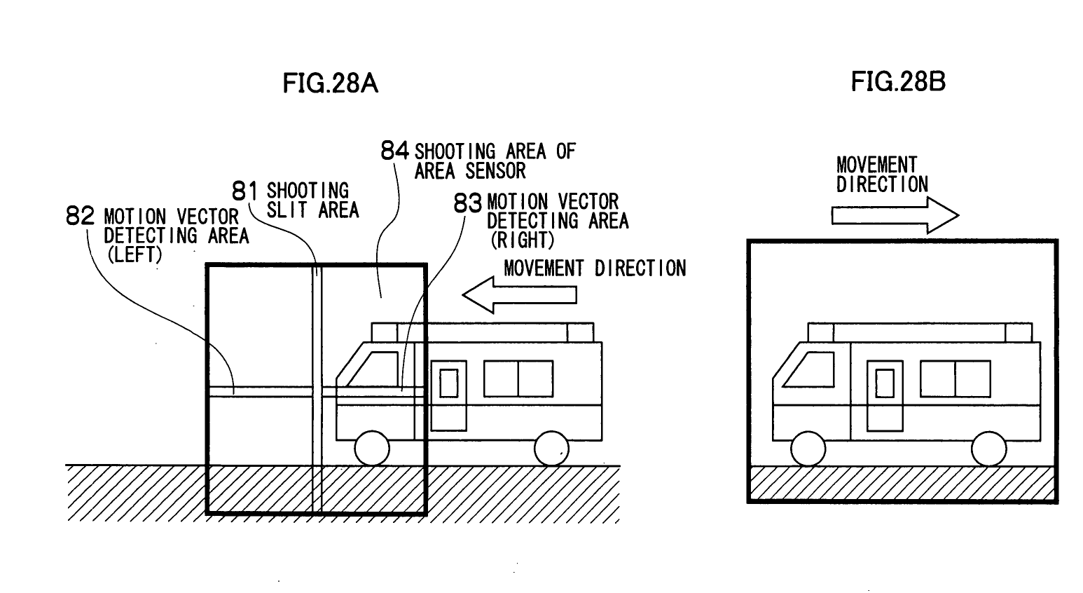

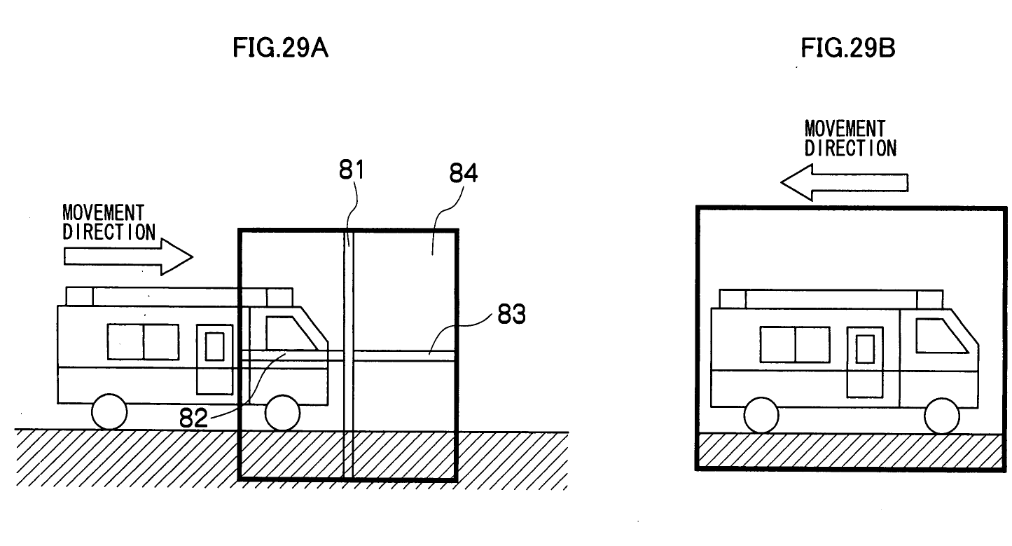

FIG. 28A is a schematic view illustrating the slit shooting in which the object moves leftward. FIG. 28B is a schematic view in which the shot slit image is spliced to the right side of the latest shot image. FIG. 29A a schematic view illustrating the slit shooting in which the object moves rightward. FIG. 29B is a schematic view in which the shot slit image is spliced to the left side of the latest shot image.

Thus, the direction in which an object moves is detected to determine as to whether the shot slit image is spliced to the left side or the right side of the latest shot image, thereby allowing producing a long panoramic image with a correct direction.

In the present embodiment, although a determination is made as to whether the shot slit image is spliced to left or right side, a determination can be made as to whether the images spliced to one direction together are reversed or not after shooting. For example, first, the shot slit images are spliced to the right side of the latest shot image to produce a long panoramic image. And if the object actually moves rightward, the panoramic image may be finally reversed.

In the present embodiment, if images are divided according to the aspect ratio of the standard image and recorded in the recording medium 38 as in the third embodiment, information indicating whether the slit images shot in the panoramic image are spliced rightward or leftward is recorded in the Exif tag to enable coupling a plurality of image groups using a dedicated software to reproduce or print a long panoramic image.

### Eighth Embodiment

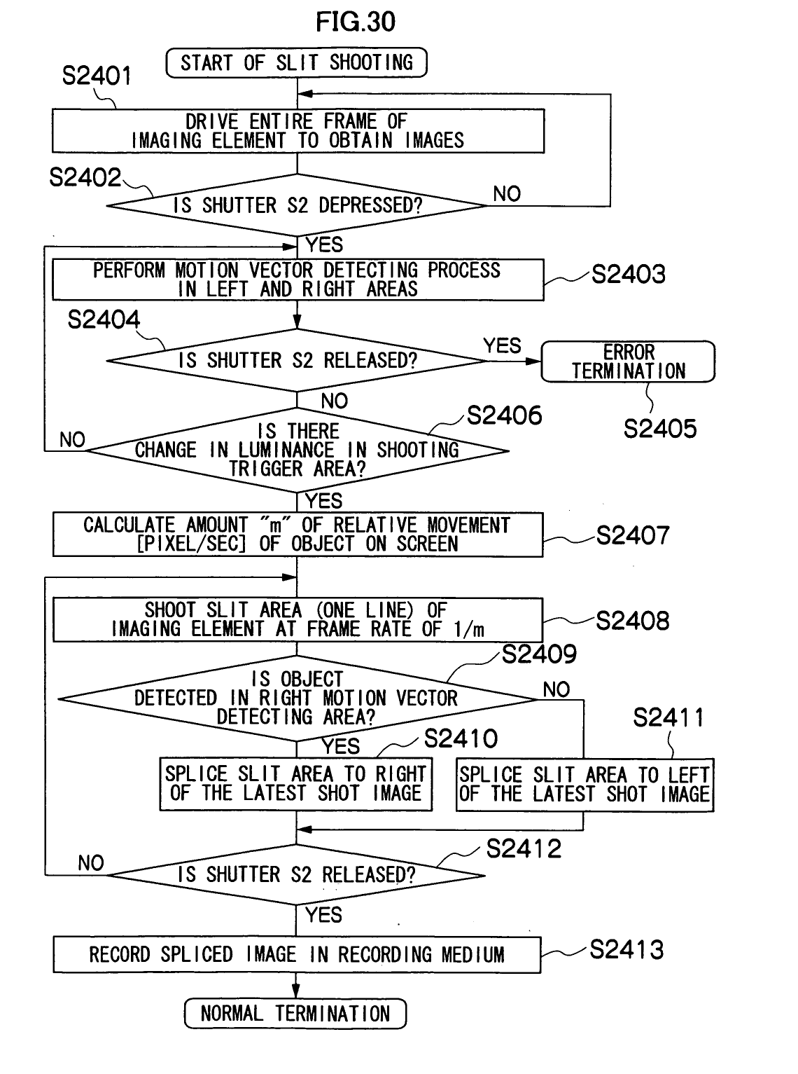

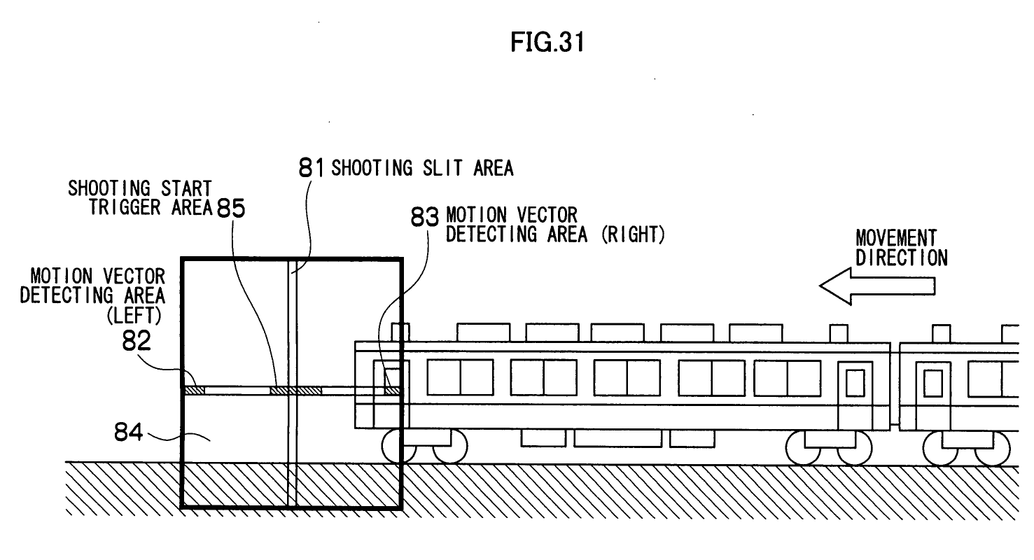

A digital camera 10 of an eighth embodiment according to the present invention is described with reference to FIGS. 30 and 31. The digital camera of the eighth embodiment performs a slit shooting in the mode for reading only the pixels on the specific line as in the first embodiment and automatically starts shooting the slit image when an object enters a trigger area on the shooting screen. The direction in which the shot slit images are spliced together is determined depending on whether the object is detected in the left or the right motion vector detecting area.

FIG. 30 is a flow chart illustrating the operation of the digital camera 10 of the eighth embodiment.

When the slit shooting mode is set, the driving system of the CCD 45 is set to the all pixel driving mode (step S2401). A determination is made as to whether the shutter button 13 is fully-depressed (step S2402). The camera is maintained in the standby state until the shutter button 13 is fully-depressed. When the shutter button 13 is fully-depressed, the motion vector detecting process is performed (step S2403). The motion vector detecting process is the same as in the first embodiment. As described above, the motion vector detecting circuit has the motion vector detecting area (left) 82 and the motion vector detecting area (right) 83 to detect the motion vector in the two areas. Following the state where there is no object in the shooting area 84, if the motion vector of an object is detected in the motion vector detecting area (left) 82, it is found that the object moves from left to right. If the motion vector of the object is detected in the motion vector detecting area (right) 83, it is found that the object moves from right to left.

A determination is made as to whether the shutter button 13 being fully-depressed is released (step S2404). If the shutter button 13 being fully-depressed is released, the process is terminated without the slit shooting (step S2405). If the shutter button 13 is not released, it is determined whether there is a change in luminance in a shooting trigger area 85 (step S2406).

The shooting trigger area 85 is described with reference to FIG. 31. FIG. 31 is a schematic view illustrating the slit shooting and illustrates that a train as an object moves from right to left on the figure. The portions common to those in the first embodiment in FIG. 6 are designated by the same reference numerals and characters and the detailed description thereof is omitted.

The digital camera 10 of the eighth embodiment has the shooting trigger area 85 between the motion vector detecting area 82 and the motion vector detecting area 83, as illustrated in FIG. 31. The shutter button 13 is fully-depressed and the motion vector process is finished. Thereafter, if the luminance in the shooting trigger area 85 is changed, the camera automatically starts shooting. At this point, the signal charges of all pixels are read in the all pixel driving mode, but only data in the shooting trigger area is used to detect change in luminance.

If the luminance in the shooting trigger area 85 is not changed, the process returns to the step S2403 to perform the vector detecting process.

If the luminance in the shooting trigger area 85 is changed, the amount “m” of relative movement of the object on the screen is calculated from the detected motion vector (step S2407), the all pixel driving mode is changed over to the specific line driving mode and the shooting slit area 81 is shot in 1/m cycle based on the amount “m” of relative movement (step S2408).

A determination is made as to whether the object is detected in the left or the right motion vector detecting area (step S2409). As stated above, the motion vector detecting circuit has the left and the right motion vector detecting area, so that it can be determined whether the object moves from left to right or from right to left on the shooting screen depending on whether the motion vector is detected in the left or the right motion vector detecting area.

If the object is detected in the motion vector detecting area (left) 82, the object moves from left to right, so that the shot slit image is spliced to the left side of the latest shot image (step S2411). On the other hand, if the object is detected in the motion vector detecting area (right) 83, the object moves from right to left, so that the shot slit image is spliced to the right side of the latest shot image (step S2410).

After finishing splicing the slit images, a determination is made as to whether the shutter button 13 being fully-depressed is released. If the shutter button 13 is not released, the process returns to the step S2408 and the slit image is shot in 1/m cycle and similarly spliced to the right or the left side of the latest shot image.

If the shutter button 13 being fully-depressed is released, the spliced images are recorded in the recording medium 38 and the slit shooting is terminated.

Thus, reading change in the luminance in the shooting trigger area 85 to start shooting enables producing a long panoramic image without a useless blank.

### Ninth Embodiment

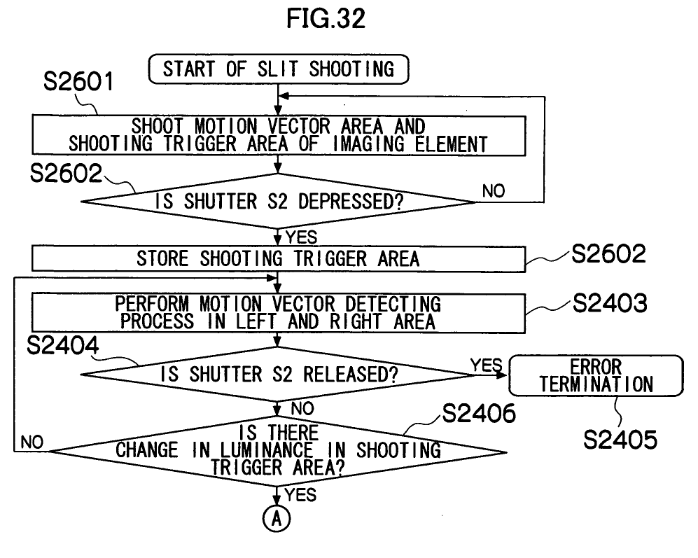

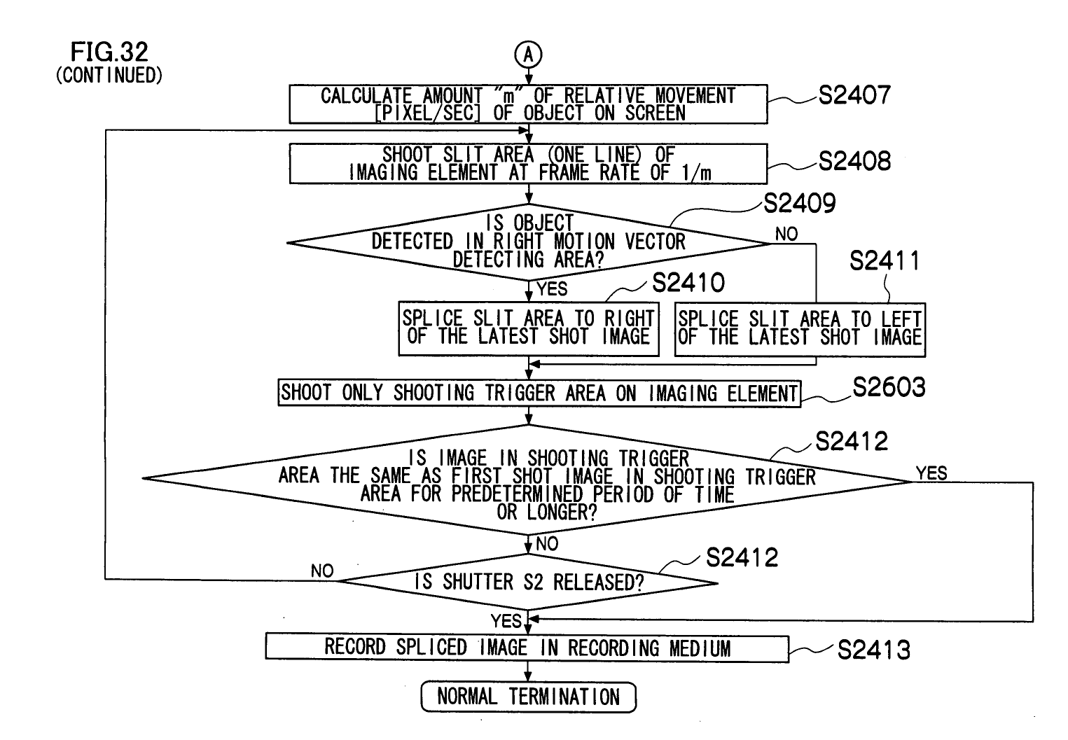

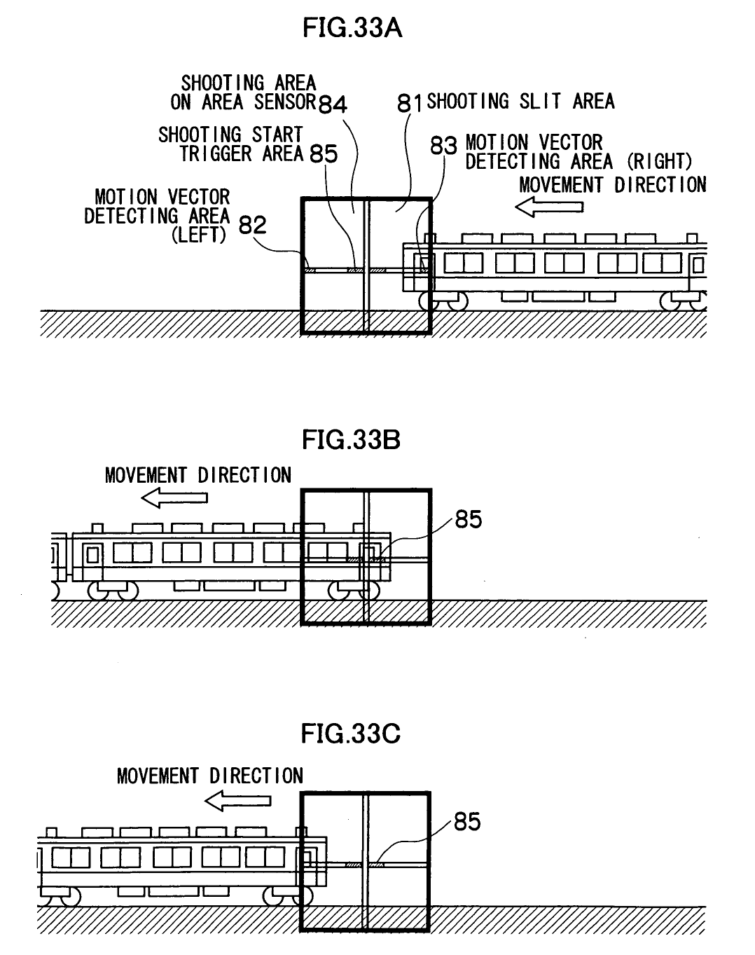

A digital camera 10 of a ninth embodiment according to the present invention is described with reference to FIGS. 32, 33A, 33B and 33C. The digital camera of the ninth embodiment performs a slit shooting in the mode for reading only the pixels on the specific line using the CMOS as an imaging element as in the second embodiment and automatically stops shooting the slit image when an object passes through the trigger area on the shooting screen.

FIG. 32 is a flow chart illustrating the operation of the digital camera 10 of the ninth embodiment. The portions common to those in the eighth embodiment illustrated in FIG. 30 are designated by the same reference numerals and characters and the detailed description thereof is omitted.

The slit shooting mode is set in which only a part of the shooting area 84 is shot (step S2601). As described above, the use of the CMOS 51 as an imaging element allows reading the signal charge of arbitrary pixel in the shooting area 84. Here, the setting is so performed as to read only the pixels in the motion vector detecting area (left) 82 and the motion vector detecting area (right) 83 and the shooting trigger area 85.

A determination is made as to whether the shutter button 13 is fully-depressed (step S2402). The camera is maintained in the standby state until the shutter button 13 is fully-depressed. When the shutter button 13 is fully-depressed, an image in the shooting trigger area is shot and the shot image is recorded (step S2602).

After that, the motion vector process is performed as in the eighth embodiment (step S2403) and a determination is made as to whether the shutter button 13 being fully-depressed is released (step S2404). If the shutter button 13 being fully-depressed is released, the process is terminated without the slit shooting (step S2405). If the shutter button 13 is not released, it is determined whether there is a change in the luminance in the shooting trigger area 85 (step S2406). At this point, only an image in the shooting trigger area 85 is shot to determine whether there is a change in the luminance.

If there is no change in the luminance in the shooting trigger area 85, the process returns to the step S2403 to perform the motion vector detecting process. If there is change in the luminance in the shooting trigger area 85, the amount “m” of relative movement of the object on the screen is calculated from the detected motion vector (step S2407) and the slit area is shot in 1/m cycle based on the determined amount “m” of relative movement (step S2408).

Next, a determination is made as to whether an object is detected in the left or the right motion vector detecting area (step S2409). If the object is detected in the motion vector detecting area (left) 82, the object moves from left to right, so that the shot slit image is spliced to the left side of the latest shot image (step S2411). On the other hand, if the object is detected in the motion vector detecting area (right) 83, the object moves from right to left, so that the shot slit image is spliced to the right side of the latest shot image (step S2410).

After finishing splicing the slit images, an image in the shooting trigger area 85 is shot (step S2603). A determination is made as to whether the shot image is the same as the image shot at the step S2602 for a predetermined period of time or longer (step S2604).

The image in the shooting trigger area 85 is described with reference to FIGS. 33A, 33B and 33C. The image in the shooting trigger area 85 is shot before the object passes at the step S2602, so that the background image is shot as illustrated in FIG. 33A. In this state, shooting starts when the object enters the shooting trigger area 85. As illustrated in FIG. 33B, the object is shot in the shooting trigger area 85 while the object is passing. In addition, as illustrated in FIG. 33C, when the object has passed, the image in the shooting trigger area 85 becomes the same background image as the first shot image. That is to say, a determination is made at the step S2604 whether the object has already passed depending on whether the image is the same as the first shot image.

If the image in the shooting trigger area 85 is different from the first shot image in the shooting trigger area 85, it is determined that the object is passing, and a determination is made as to whether the shutter button 13 being fully-depressed is released (step S2412). If the shutter button 13 is not released, the process returns to the step S2408 to continue shooting.

If the image in the shooting trigger area 85 is the same as the first shot image in the shooting trigger area 85 for a predetermined period of time or longer, it is determined that the object has already passed through the shooting slit area, and the spliced images are recorded in the recording medium 38 (step S2413). The slit shooting is terminated. If the shutter button 13 being fully-depressed is released, the slit shooting is terminated.

Thus, the passage of the object is determined from the image in the shooting trigger area 85 and the slit shooting is terminated when it is determined that the object has passed, thereby enabling producing a long panoramic image without a useless blank.

### Tenth Embodiment

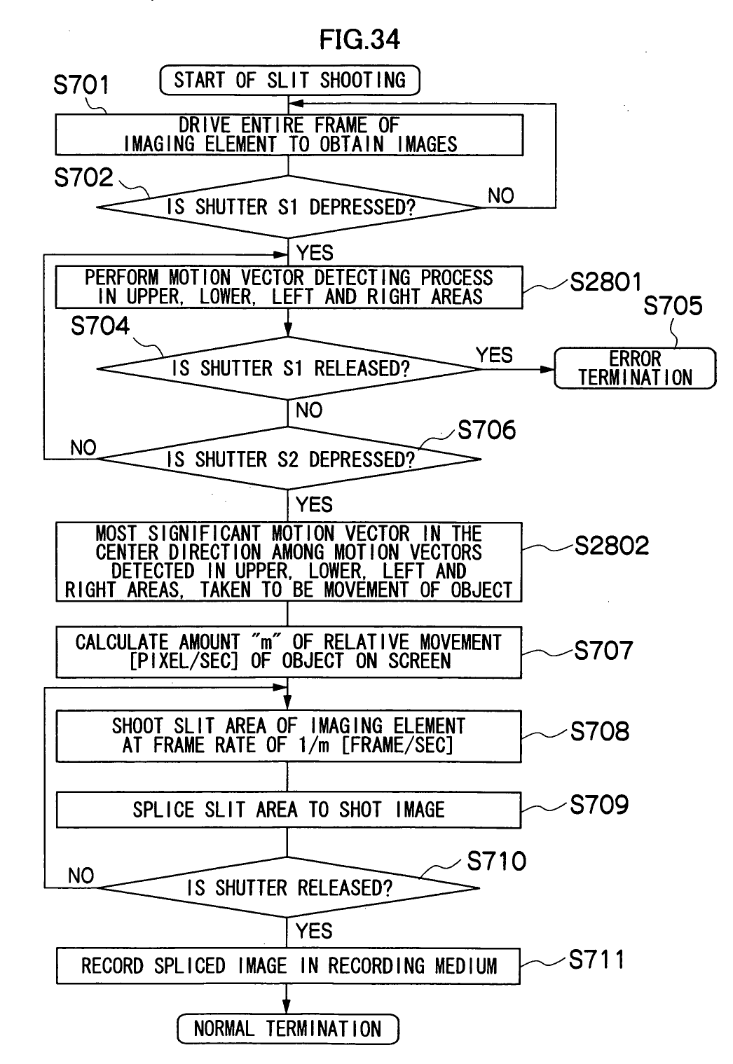

A digital camera 10 of a tenth embodiment according to the present invention is described with reference to FIGS. 34, 35, 36A, 36B, 36C and 36D. The digital camera 10 of the tenth embodiment is provided with an upper, a lower, a left and a right motion vector detecting area on the screen, and the horizontal shooting slit area as well as the vertical shooting slit area. The most significant motion vector in the center direction detected in the four motion vector detecting areas is regarded as the movement of the object and shooting is performed in the shooting slit area perpendicular to the motion vector. In addition, the CMOS 51 is used as an image element as in the second embodiment.

FIG. 34 is a flow chart illustrating the operation of the digital camera 10 of the tenth embodiment. The portions common to those in the first embodiment illustrated in FIG. 7 are designated by the same reference numerals and characters and the detailed description thereof is omitted.

As is the case with the first embodiment, when the camera is set to the slit shooting mode, the driving system of the CCD 45 is set to the all pixel driving mode (step S701) and a determination is made as to whether the shutter button 13 is half-depressed (step S702). The camera is kept in the standby state until the shutter button 13 is half-depressed. When the shutter button 13 is half-depressed, a motion vector detecting process is performed (step S2801).

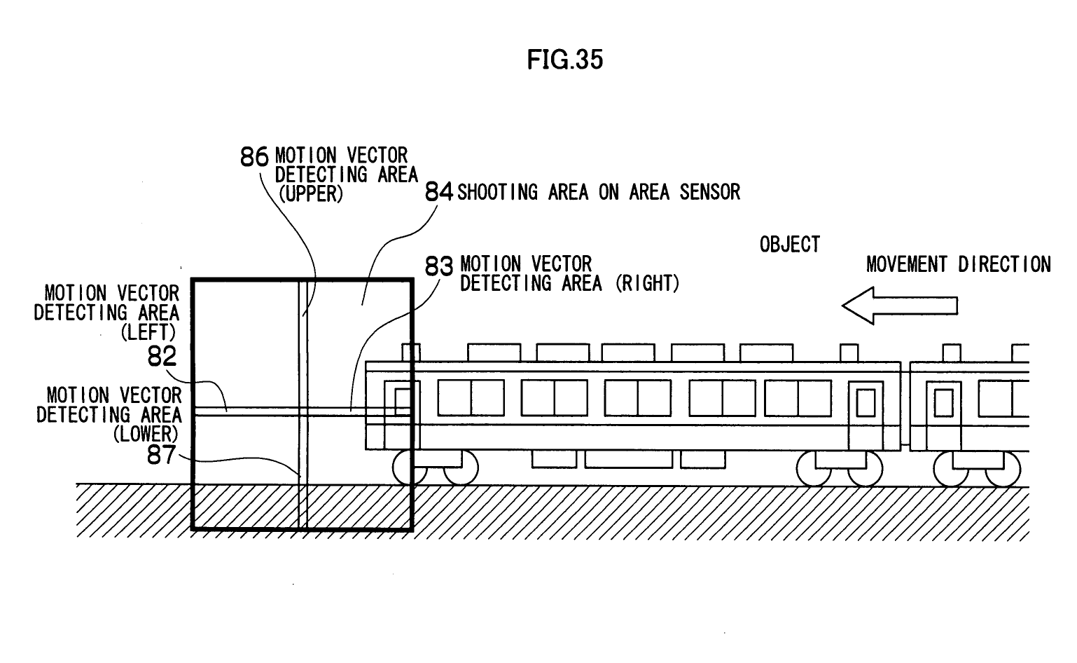

The motion vector detecting process of the digital camera 10 is described below with reference to FIG. 35. FIG. 35 is a schematic view of the slit shooting by using the digital camera 10. As illustrated in FIG. 35, the digital camera 10 is provided with the four motion vector detecting areas in the shooting area 84 in the cross direction: the motion vector detecting area (left) 82; the motion vector detecting area (right) 83; the motion vector detecting area (upper) 86; and the motion vector detecting area (lower) 87. The motion vector detecting process is performed in the four motion vector detecting areas. How to detect the motion vector is the same as in the firth embodiment, so that the description thereof is omitted.

After that, if it is determined that the shutter button 13 is fully-depressed (step S706), the movement of an object is determined (step S2802). Here, the most significant motion vector in the center direction among the motion vectors detected in the four motion vector detecting areas is regarded as the movement of the object.

The amount “m” of relative movement of the object on the screen is calculated based on the motion vector of the object (step S707) to perform shooting at 1/m cycle (step S708).

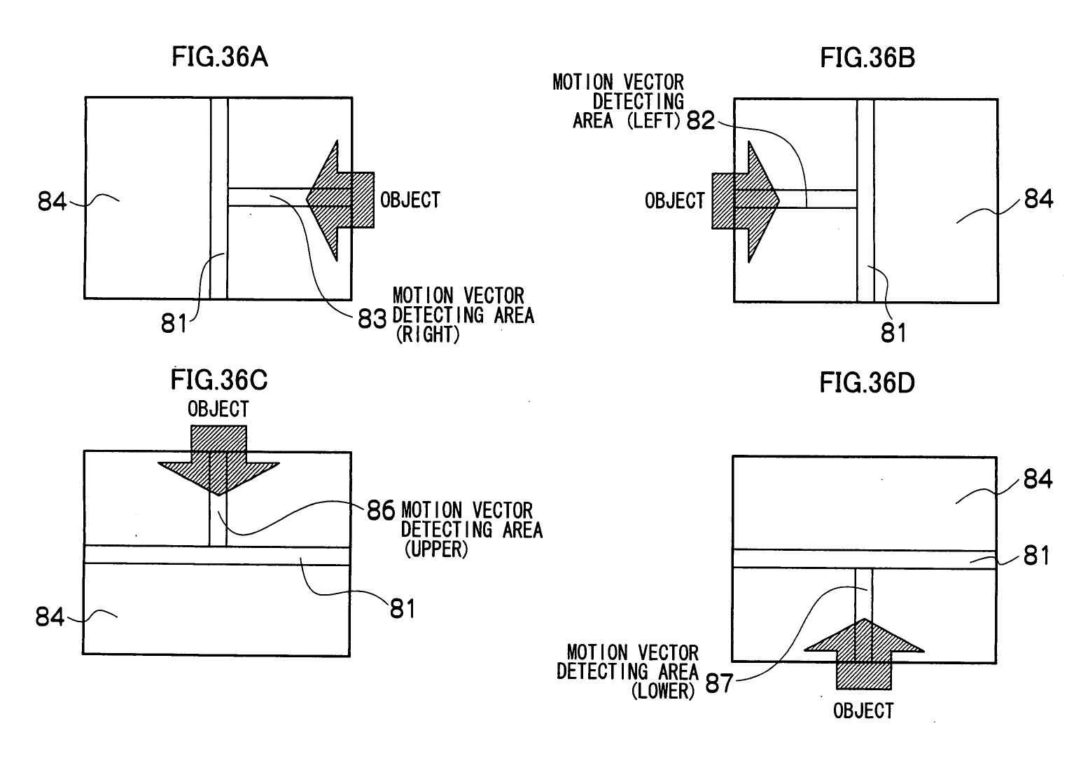

The shooting slit area 81 is described with reference to FIGS. 36A, 36B, 36C and 36D. FIGS. 36A, 36B, 36C and 36D are schematic views illustrating a relationship between the motion vector detecting area and the shooting slit area 81. As illustrated in FIGS. 36A and 36B, if the leftward motion vector is detected in the motion vector detecting area (right) 83 or if the rightward motion vector is detected in the motion vector detecting area (left) 82, the shooting slit area 81 is set to a vertical slit. On the other hand, if the downward motion vector is detected in the motion vector detecting area (upper) 86 or if the upward motion vector is detected in the motion vector detecting area (lower) 87, the shooting slit area 81 is set to a horizontal slit. Thus, the shooting slit area 81 can be changed over to the horizontal or the vertical direction with respect to the screen, and the direction of the shooting slit area 81 perpendicular to the motion vector of the object is determined. In an example illustrated in FIG. 35, a leftward motion vector is detected in the motion vector detecting area (right) 83 and the shooting slit area 81 is in the vertical direction perpendicular to the motion vector.

When the shooting of the slit image has been finished, the shot image is spliced to the latest shot image (step S709). As illustrated in FIG. 36A, if the motion vector of the object is detected in the motion vector detecting area (right) 83, the shot image is spliced to the right side of the latest shot image. As illustrated in FIG. 36B, if the motion vector of the object is detected in the motion vector detecting area (left) 82, the shot image is spliced to the left side of the latest shot image. As illustrated in FIG. 36C, if the motion vector of the object is detected in the motion vector detecting area (upper) 86, the shot image is spliced to the upper side of the latest shot image. As illustrated in FIG. 36D, if the motion vector of the object is detected in the motion vector detecting area (lower) 87, the shot image is spliced to the lower side of the latest shot image. In an example illustrated in FIG. 35, the shot image is spliced to the right side of the latest shot image.

Shooting is thus performed. If the shutter button 13 being fully-depressed is released (step S710), the spliced images are recorded in the recording medium 38 (step S711) and the slit shooting is terminated.

Thus, the direction of the shooting slit area 81 is changed based on the direction in which the object moves to allow an appropriate slit shooting.

In the present embodiment, if images are divided according to the aspect ratio of the standard image and recorded in the recording medium 38 as in the third embodiment, information indicating whether the slit images shot in the panoramic image are spliced rightward, leftward, downward or upward is recorded in the Exif tag to enable coupling a plurality of image groups using a dedicated software to reproduce or print a long panoramic image.

### Eleventh Embodiment

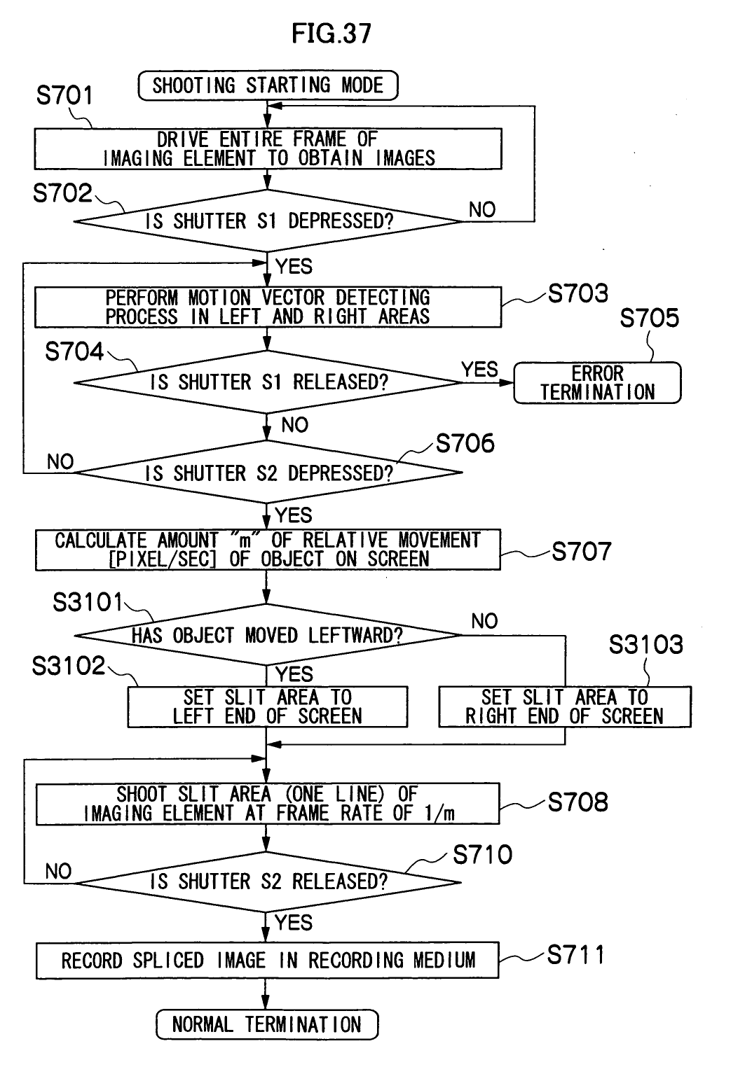

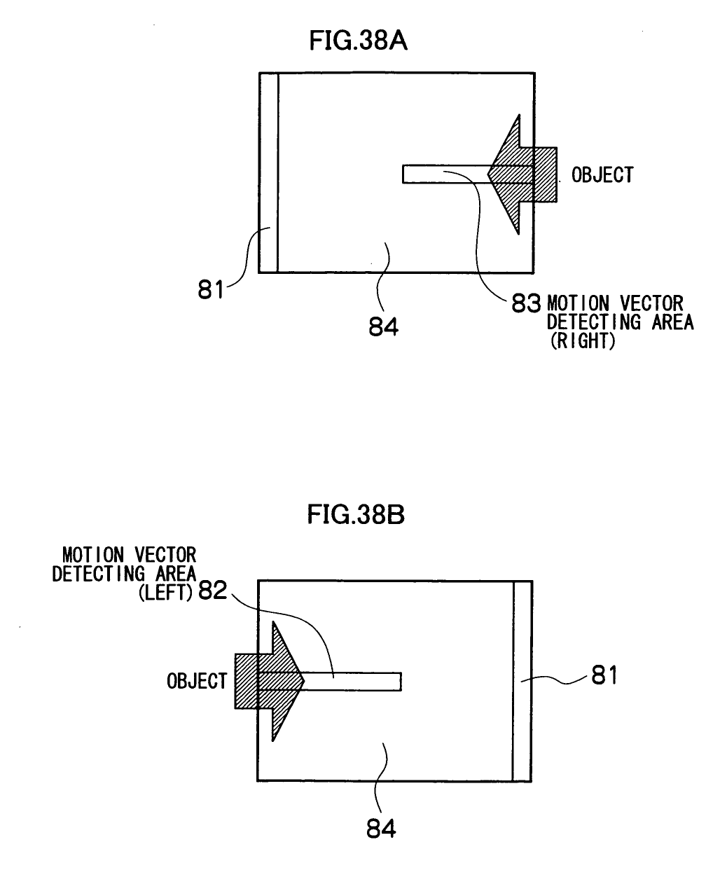

A digital camera 10 of an eleventh embodiment according to the present invention is described with reference to FIGS. 37, 38A and 38B. The digital camera of the eleventh embodiment performs a slit shooting in the mode for reading only the pixels on the specific line using the CMOS as an imaging element as in the second embodiment and changes the place of the shooting slit area depending on the direction in which an object moves.

FIG. 37 is a flow chart illustrating the operation of the digital camera 10 of the eleventh embodiment. The portions common to those in the first embodiment illustrated in FIG. 7 are designated by the same reference numerals and characters and the detailed description thereof is omitted.

As is the case with the first embodiment, half-depressing the shutter button 13 in the slit shooting mode causes the camera to perform the motion vector detecting process. Thereafter, fully-depressing the shutter button 13 causes the camera to calculate the amount “m” of relative movement of the object on the screen based on the motion vector (steps S701 to S707).

A determination is made as to whether an object moves rightward or leftward (step S3101) and the place of the shooting slit area 81 is determined.

FIGS. 38A and 38B are schematic diagrams illustrating the direction in which the object moves and the shooting area 84. As illustrated in FIG. 38A, if the object moves from right to left in the shooting area 84, the shooting slit area 81 is set to the left end of the screen (step S3102). On the other hand, as illustrated in FIG. 38B, if the object moves from left to right in the shooting area 84, the shooting slit area 81 is set to the right end of the screen (step S3103).

A shooting is performed in 1/m cycle in the set shooting slit area 81 (step S708) and the shot slit images are spliced together. A determination is made as to whether the shutter button 13 being fully-depressed is released (step S710). If the shutter button 13 is not released, the process returns to the step S708 to continue shooting. If the shutter button 13 being fully-depressed is released, the spliced images are recorded in the recording medium 38 (step S711) and the slit shooting is terminated.

Thus, changing the place of the shooting slit area depending upon the direction in which the object moves enables shooting the front end of the object in the shooting slit area 81 during the time period from the half-depression of the shutter button 13 to the full-depression of the shutter button 13, however fast the object moves.

What is claimed is:

1. An imaging device having a slit image shooting device which reads a slit image from a slit shooting area on an area sensor to shoot the slit image and a panoramic image forming device which splices the shot slit images together to produce a long panoramic image, the imaging device comprising:
a motion detecting device which reads an image from a motion detecting area on the area sensor at a predetermined cycle and detects an amount of relative movement of an object on the area sensor per unit time based upon the read image; and
a control device which controls a reading cycle to read a slit image by the slit image shooting device based upon the detected amount of relative movement and a slit width of the slit shooting area to produce a panoramic image with a correct aspect ratio.

2. The imaging device according to claim 1, wherein
the motion detecting device reads an image from the motion detecting area on the area sensor before the slit image shooting device starts shooting the slit image and
the control device causes the slit image shooting device to start shooting the slit image after the motion detecting device has detected the amount of relative movement of the object.

3. The imaging device according to claim 1, further comprising
a shutter button which instructs the imaging device to perform a shooting preparation operation when it is half-depressed and to perform a shooting operation when it is fully-depressed, wherein
the motion detecting device reads an image from the motion detecting area on the area sensor at the predetermined cycle when the shutter button is half-depressed and
the control device causes the slit image shooting device to start shooting the slit image when the shutter button is fully-depressed.

4. The imaging device according to claim 1, wherein
the motion detecting areas on the area sensor are provided on the left and the right of the slit shooting area,
the motion detecting device detects the object moving relatively rightward on the area sensor based on the image obtained from the left motion detecting area and detects the object moving relatively leftward on the area sensor based on the image obtained from the right motion detecting area, and
the panoramic image forming device splices the slit images together leftward when the motion detecting device detects that the object moves relatively rightward on the area sensor and splices the slit images together rightward when the motion detecting device detects that the object moves relatively leftward, to form a long panoramic image.

5. The imaging device according to claim 1, further comprising:
a shooting trigger area which is set inside of a left and a right motion detecting areas on the area sensor, the left and the right motion detecting areas are provided on the left and the right of the slit shooting area and on the end of the area sensor; and
a shooting trigger detecting area which detects change in the image in the shooting trigger area, wherein
the control device causes the slit image shooting device to start reading the slit image, when the motion detecting device detects the movement of the object based on the image of the left or the right motion detecting area and the shooting trigger detecting device detects change in the image in the shooting trigger area.

6. The imaging device according to claim 1, further comprising:
a shooting finish trigger area which is set inside of a left and a right motion detecting areas on the area sensor, the left and the right motion detecting areas are provided on the left and the right of the slit shooting area and on the end of the area sensor; and
a shooting-finish trigger detecting device which detects as to whether the image before shooting is started coincides with the image after shooting is started, in the shooting finish trigger area, wherein
the control device causes the slit image shooting device to stop shooting the slit image, when the shooting-finish trigger detecting device detects the coincidence of the images for a certain time period or more after the slit image shooting device has started reading the slit image.

7. The imaging device according to claim 1, further comprising:
a storing device which stores a first slit image shot by the slit image shooting device before the motion detecting device detects the amount of motion of the object in the motion detecting area;
a background detecting device which compares a first slit image stored in the storing device with a second slit image sequentially shot by the slit image shooting device, and detects a background image of the object from the second slit image; and
a replacing device which replaces the detected background image out of the second slit images with an image in a specified color.

8. An imaging device having a slit image shooting device which reads a slit image from a slit shooting area on an area sensor to shoot the slit image and a panoramic image forming device which splices the shot slit images together to produce a long panoramic image, the imaging device comprising:
a motion detecting device which reads an image from a motion detecting area on the area sensor at a predetermined cycle and detects, based upon the read image, an amount of relative movement of an object on the area sensor per reading cycle for reading the slit image by the slit image shooting device; and
a control device which controls a slit width of the slit shooting area so that the detected amount of relative movement coincides with the slit width of the slit shooting area.

9. The imaging device according to claim 1, wherein
the motion detecting device detects the amount of relative movement of the object orthogonal to the slit shooting area.

10. The imaging device according to claim 8, wherein
the motion detecting device reads an image from the motion detecting area on the area sensor before the slit image shooting device starts shooting the slit image and
the control device causes the slit image shooting device to start shooting the slit image after the motion detecting device has detected the amount of relative movement of the object.

11. The imaging device according to claim 8, further comprising
a shutter button which instructs the imaging device to perform a shooting preparation operation when it is half-depressed and a shooting operation when it is fully-depressed, wherein
the motion detecting device reads an image from the motion detecting area on the area sensor at the predetermined cycle when the shutter button is half-depressed and
the control device causes the slit image shooting device to start shooting the slit image when the shutter button is fully-depressed.

12. The imaging device according to claim 2, wherein
the area sensor is a CCD area sensor,
the motion detecting device reads an image from all pixels on the CCD area sensor, and
the slit image shooting device reads the slit image only from one to plural horizontal lines of the CCD area sensor at a faster rate than reading from all pixels.

13. The imaging device according to claim 8, wherein
the motion detecting device reads an image from the motion detecting area on the area sensor before and while the slit image shooting device shoots the slit image, and
the control device causes the slit image shooting device to start shooting the slit image after the motion detecting device has detected the amount of relative movement of the object, and controls the slit width of the slit shooting area in real time so that the amount of relative movement sequentially detected by the motion detecting device coincides with the slit width of the slit shooting area.

14. The imaging device according to claim 1, wherein
the slit shooting area is a central portion of the area sensor.

15. The imaging device according to claim 8, wherein
the motion detecting areas on the area sensor are provided on the left and the right of the slit shooting area,
the motion detecting device detects the object moving relatively rightward on the area sensor based on the image obtained from the left motion detecting area and detects the object moving relatively leftward on the area sensor based on the image obtained from the right motion detecting area, and
the panoramic image forming device splices the slit images together leftward when the motion detecting device detects that the object moves relatively rightward on the area sensor and splices the slit images together rightward when the motion detecting device detects that the object moves relatively leftward, to form a long panoramic image.

16. The imaging device according to claim 8, further comprising:
a shooting trigger area which is set inside of a left and a right motion detecting areas on the area sensor, the left and the right motion detecting areas are provided on the left and the right of the slit shooting area and on the end of the area sensor; and
a shooting trigger detecting area which detects change in the image in the shooting trigger area, wherein
the control device causes the slit image shooting device to start reading the slit image, when the motion detecting device detects the movement of the object based on the image of the left or the right motion detecting area and the shooting trigger detecting device detects change in the image in the shooting trigger area.

17. The imaging device according to claim 8, further comprising:
a shooting finish trigger area which is set inside of a left and a right motion detecting areas on the area sensor, the left and the right motion detecting areas are provided on the left and the right of the slit shooting area and on the end of the area sensor; and
a shooting-finish trigger detecting device which detects as to whether the image before shooting is started coincides with the image after shooting is started, in the shooting finish trigger area, wherein
the control device causes the slit image shooting device to stop shooting the slit image, when the shooting-finish trigger detecting device detects the coincidence of the images for a certain time period or more after the slit image shooting device has started reading the slit image.

18. The imaging device according to claim 2, wherein
the motion detecting device detects the direction in which the object moves leftward, rightward, upward or downward on the area sensor, and
the slit image shooting device sets the slit shooting area to the direction orthogonal to the direction in which the object moves detected by the motion detecting device.

19. The imaging device according to claim 2, wherein
the motion detecting device detects the direction in which the object moves on the area sensor, and
the slit image shooting device sets the slit shooting area to the end of the area sensor where the rear end of the object lastly passes according to the direction in which the object moves detected by the motion detecting device.

20. The imaging device according to claim 1, further comprising
a recording device which divides the shot panoramic image so as to have the aspect ratio of the standard image, forms image files for each of the divided images and records them in the recording medium.

21. The imaging device according to claim 20, wherein
the recording device records information indicating that an image file corresponds to a series of a panoramic image, in the tags of a plurality of image files formed correspondingly with the shot panoramic image.

22. The imaging device according to claim 8, further comprising:
a storing device which stores a first slit image shot by the slit image shooting device before the motion detecting device detects the amount of motion of the object in the motion detecting area;
a background detecting device which compares a first slit image stored in the storing device with a second slit image sequentially shot by the slit image shooting device, and detects a background image of the object from the second slit image; and
a replacing device which replaces the detected background image out of the second slit images with an image in a specified color.

23. A method for producing a panoramic image using an imaging device including an area sensor, the method comprising:
reading an image from a motion detecting area on the area sensor at a predetermined cycle and detects an amount of relative movement of an object on the area sensor per unit time based upon the read image;
setting a reading cycle to read a slit image based upon the detected amount of relative movement and a slit width of a slit shooting area on the area sensor;
reading a slit image from the slit shooting area on the area sensor, a plurality of times in the set reading cycle, to shoot the slit image; and
splicing the plurality of shot slit images together to produce a panoramic image.

24. A method for producing a panoramic image using an imaging device including an area sensor, the method comprising:
reading an image from a motion detecting area on the area sensor at a predetermined cycle and detects, based upon the read image, an amount of relative movement of an object on the area sensor per reading cycle for reading a slit image from a slit shooting area on the area sensor;
determining a slit width of the slit shooting area based on the detected amount of relative movement;
reading a slit image from the slit shooting area with the determined slit width on the area sensor, in the reading cycle a plurality of times, to shoot the slit image; and
splicing the plurality of shot slit images together to produce a panoramic image.
